(19) United States
(12) Patent Application Publication
(10) Pub. No.: US 2023/0320360 A1
(43) Pub. Date: Oct. 12, 2023

(54) FORMULATIONS AND METHODS FOR REGULATING AND STIMULATING PLANT GROWTH

(71) Applicant: UPL Limited, Mumbai (IN)

(72) Inventor: Raghulal Vellayil Bhaskaran, Mumbai (IN)

(21) Appl. No.: 18/043,190

(22) PCT Filed: Sep. 1, 2021
(86) PCT No.: PCT/IB2021/057978

§ 371 Date: Feb. 27, 2023

(30) Foreign Application Priority Data
Sep. 1, 2020 (IN) 202021035283

(51) Int. Cl. A01N 43/90; A01N 57/20; A01N 47/24; A01N 43/40; A01P 3/00; A01P 13/02; A01P 21/00

(52) U.S. Cl. CPC A01N 43/90; A01N 57/20; A01N 47/24; A01N 43/40; A01P 3/00; A01P 13/02; A01P 21/00

(57) ABSTRACT

The present disclosure relates to methods and compositions for crop protection and increasing nutrition of plants. In particular, the invention relates to a method for stimulating and promoting growth of a plant and to increase yield and quality.

### CROSS REFERENCE TO RELATED APPLICATIONS

This application is a National Stage application of PCT/IB2021/057978, filed Sep. 1, 2021, which claims priority to Indian Patent Application No. 202021035283, filed Sep. 1, 2020, both of which are incorporated by reference in their entirety herein.

### FIELD OF INVENTION

The present invention relates to a method for protection and promoting the nutrition of a plant. In particular, the invention relates to a method for stimulating and promoting the growth of a plant and for increasing the yield and quality of the crop.

### BACKGROUND OF INVENTION

Sustainable agriculture is farming in sustainable ways, which means meeting society's food needs without compromising the ability of future generations to meet their needs. It can be based on an understanding of ecosystem services. It includes environmental stewardship, fairness, health, business, and familial aspects in a farm setting. There are many methods to increase the sustainability of agriculture. Sustainability focuses on the business process and practice of a farm in general, rather than a specific agricultural product.

Agriculture has an enormous environmental footprint; it is simultaneously causing environmental changes and being impacted by these changes. If the human population increase does not abate, an increase in food production will be required. Sustainable agriculture provides a potential solution to enable agricultural systems to feed a growing population within the changing environmental conditions.

Sustainable agriculture can be defined as an integrated system of plant and animal production practices having a site-specific application that will, over the long term satisfy human food and fiber needs, enhance environmental quality and the natural resource based upon which the agriculture economy depends; make the most efficient use of non-renewable resources and on-farm resources and integrate, where appropriate, natural biological cycles and controls; sustain the economic viability of farm operations; enhance the quality of life for farmers and society as a whole.

There is a desirous need in the society for continuous research to be conducted on sustainable agriculture to develop agricultural practices which lead to sustainable growth with minimum environmental impact, enhance the plant protection, and benefit the farmers.

Nutrients contribute to efficient nutrition of plants when nutrition from the soil is inefficient and to correct deficiencies during development, flowering and fruit production. Plant growth stimulators are used to increase biomass, manage the rate of growth and to increase yield and quality of the crops. These products are also used to manage abiotic stresses such as cold stress, drought stress, and the like. In many horticultural and agricultural applications, plant growth regulators (growth inhibitors or growth stimulants) are applied for a variety of reasons.

One of the challenges of modern agriculture is to address the social demand for sustainability, quality, and safety in agricultural production and to adapt itself to the world population increase by improving yields and crop tolerance to a changing environment.

Biosolutions can be used to improve plant nutrition, which impacts yield and quality parameters. Plant biostimulants are used to treat crops in a commercial setting in view of their ability to increase growth rates, increase stress tolerance, increase photosyntheis rates and increase disease tolerance. Plant biostimulants are generally believed to operate by up-regulating or down-regulating key biological pathway genes.

Extreme temperatures, irregular rainfall and other stressful growing conditions related to climate change require resilient crops. Biostimulants or biological control agents are used to increase plant tolerance and recovery from abiotic stresses. This means a higher return on investment for farmers and better use of the natural resources from which many crop nutrition products are derived. Biostimulants help to protect and improve soil health by fostering the development of beneficial soil microorganisms. Healthier soil retains water more effectively and better resists erosion. Increasing yields is at the heart of farmers' concerns. However, the yield depends greatly on the good development of the plant and therefore its growth, as well as its good health is important.

There is a need to obtain a better quality of the final fruit or grain obtained, translated, for example, by the size of the fruit of the plants or by the nutritional quality obtained in the fruit or grain, resulting in a harvest of great appreciation of the agricultural commodity. Further it is desired to have the greatest quantity of fruit or grain produced and improve the crop yield of the crop. Furthermore, it is important that a significant reduction of the time of harvest, in the form of obtaining the acceleration of the closing of the planting lines, with early flowering of the crop plant, which, consequently, anticipates obtaining the fruit or grain at its optimum harvest point. However, from an economic point of view, the optimum results obtained from a crop, in qualitative, quantitative and temporal aspects, must be considered as the imperative goal to minimize the economic risks to agricultural producers.

Therefore, new agriculture products and unique methods for improving the plant growth and development as well as crop yield are needed. The present invention thus provides a complete solution from pre-sowing to post-harvest for agriculture.

The present inventor, with an expertise in technological development in the agricultural sector identified the farmer's need to potentiate the results of a crop, under the qualitative, quantitative and temporal orders, considering the unavoidable fact that the agricultural crop plants of interest are subject to biotic and/or abiotic factors.

The present invention therefore provided a sustainable agriculture method and a complete package of solution to the farmers/growers that provide qualitative, quantitative results with good development of the plant.

### SUMMARY OF INVENTION

In an aspect the present invention relates to a unique method for providing protection and nutrition to the plant.

In another aspect the present invention provides a method for complete pesticidal solution for crops comprising applying an effective amount of at least one pesticide and at least one biostimulant or biological control agent.

In another aspect the present invention provides an integrated crop health solution to meet the needs of farmers/growers.

In another aspect the present invention provides a method for supporting sustainable agricultural practices by providing crop solutions which plant needs throughout the season or at a specific development stage of the crop are addressed.

In another aspect the present invention is directed towards improving grower economic need to meet evolving food chain requirements. The advantages of the invention include managing resistance and residues, enhancing crop protection, targeting higher yields and better-quality products/food.

In another aspect the method of present invention promotes maximum genetic potential of the crop and mitigate the stress factors by using present composition that combines essential nutrients with natural plant extracts that biologically activate plant functions with conventional crop protection products. The activation of plant functions helps the formation of plant metabolites and trigger biochemical reactions that promotes plant growth and performance.

In another aspect the present invention provides an integrated programme with one stop solution to provide nutrition with certain active ingredients that have an impact on a crop at different life stages.

In some aspect, embodiments herein provide methods of stimulating or promoting plant growth comprising applying to a crop plant a composition comprising at least pesticide and at least one biostimulant or biocontrol agent in an amount sufficient to stimulate or promote plant growth.

### BRIEF DESCRIPTION OF DRAWINGS

FIG. 1a and FIG. 1b represents crop vigour and enhanced plant health according to the present invention as demonstrated in Example 10.

### DESCRIPTION OF PRESENT INVENTION

Before describing the present invention in detail, it is to be understood that this invention is not limited to particularly exemplified systems or process parameters that may of course, vary.

For the purposes of the following detailed description, it is to be understood that the invention may assume various alternative variations and step sequences, except where expressly specified to the contrary. Moreover, other than in any operating examples, or where otherwise indicated, all numbers expressing, for example, quantities of materials/ingredients used in the specification are to be understood as being modified in all instances by the term “about”.

It is noted that, unless otherwise stated, all percentages given in this specification and appended claims refer to percentages by weight of the total composition. It is also to be understood that the terminology used herein is for the purpose of describing particular embodiments of the invention only and is not intended to limit the scope of the invention in any manner. The use of examples anywhere in this specification including examples of any terms discussed herein is illustrative only, and in no way limits the scope and meaning of the invention or of any exemplified term. Likewise, the invention is not limited to various embodiments given in this specification. Unless otherwise defined, all technical and scientific terms used herein have the same meaning as commonly understood by one of ordinary skill in the art to which this invention pertains. In the case of conflict, the present document, including definitions will control.

It must be noted that, as used in this specification, the singular forms “a,” “an” and “the” include plural referents unless the content clearly dictates otherwise. The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

As used herein, the terms “comprising” “including,” “having,” “containing,” “involving,” and the like are to be understood to be open-ended, i.e., to mean including but not limited to.

As used herein, “plant” embraces plant crops (or just crops), ornamentals, trees, grasses, annuals, perennials or any other commonly cultivated member of the kingdom Plantae.

The term “crop plant(s)” as used herein, includes any edible or non-edible plant, including decorative, plant species with commercial value, which is planted and cultivated for commercial use. Thus, crop plants include floral and non-floral plants, perennials and annuals, trees, shrubs, vegetable plants, fruit trees, turf, and ground cover. Non-limiting specific examples of crop plants include canola, flax, peas, lentils, beans, linola, mustard, chickpeas, sunflowers, potatoes, seedling alfalfa, onions, soybeans, and turf grass. The term “plants” is meant to include germinant seeds, cuttings, emerging seedlings, and established vegetation, including roots and above-ground portions, for example, leaves, stalks, flowers, fruits, branches, limbs, root, and the like.

The term “locus” as used herein shall denote the vicinity of a desired crop in which control is desired. For example the locus includes the vicinity of desired crop plants wherein the fungal infestation has occurred or is expected to occur. The term crop shall include a multitude of desired crop plants or an individual crop plant growing at a locus.

The term “an amount of sufficient to stimulate or promote plant growth” means any amount of active compound or biostimulant or biocontrol agent capable of increasing seedling germination, plant height, biomass, enhancing color, and the like, relative to an untreated control. In general, the amount sufficient to stimulate plant growth may be within the application rate range from about 1 gram to about 3000 grams of active ingredient per hectare.

In an aspect the present invention provides an effective, sustainable solution for farmers that maximizes productivity, quality, and profitability in several crops, potentiating the results of the grower's business. The main goal of the present invention is to strengthen the concept of plant health, which is to care for all the crop cycle in an integrated way, from planting stage to harvest. Therefore, it is necessary to have a synergy between crop protection and the most modern technologies that stimulate and strengthen the plant. The present methods comprise application of one or more plant health compositions comprising at least one biological control agent and at least one agrochemical pesticidal chemical at different stages of the plant in the field.

In some embodiments, there are provided methods comprising applying to a crop plant a composition comprising pesticides and biostimulant or biological control agent in an amount sufficient to stimulate plant growth, to accelerate growth, to improve fruit quality and to increase crop yields.

In some embodiments, there are provided methods comprising applying to a crop plant a composition comprising at least one pesticide and at least one biostimulant in an amount sufficient to stimulate plant growth, to accelerate growth, to improve fruit quality and to increase crop yields.

Since the environmental and economic requirements imposed on modern-day crop protection compositions are continually increasing, with regard, for example, to the spectrum of action, toxicity, selectivity, application rate, formation of residues, and favourable preparation ability, and since, furthermore, there may be problems, for example, with resistances. A constant task is to develop new agrochemical compositions as well as new crop management programmes, which in some areas at least help to fulfil the abovementioned requirements.

The demand for global average production of crops for example rice, wheat, maize, and the like, is increasing along with the rise in population. On the other hand, growers face many challenges in meeting the growing food demand. An additional challenge for the growers is to meet the rise in demand of good quality and healthy food. The consumers have become more conscious about the food they are consuming. Thus, the necessity of 100% healthy food and pesticide residue free food is in high demand. In order to meet this global need for sustainable food production and grower's financial stability with reduced arable land and climate change, crop production intensification will be an absolute necessity.

Besides, there are different stages in the life cycle of the crop starting with establishment until the final packaging and storage, and every stage is important to build the yield and quality of the crop. In order to exploit all crop yield potential, the importance of crop nutrition and production is well known to the growers. Still, complementary solutions such as biostimulant are not widely used. The present invention comprises a combined biosolutions product containing biocontrol agents and/or biostimulants and innovative nutrition with reduced pest resistance and long-life cycle, to solve the current issues associated with conventional crop protection products. According to the present invention the present methods promote and stimulate plant growth and reproduction, help the plant against climatic stress, feed the crop at key stage and increase the quality of crop production.

The present invention is thus directed to increasing nutrient efficiency in plants, promoting growth and managing the stress in changing environmental conditions, and providing economic benefits to the growers at the same time.

The present invention facilitates clear product positioning based on agronomic needs, which is specific to the crop and specific to each growth stage of the plant. The present invention comprises a comprehensive integrated crop health solution to meet the needs of todays growers. The present disclosure accordingly provides a complete program that integrates natural biosolutions with conventional crop protection products which covers the needs of plants throughout the crop cycle or at a specific stage of development. The main benefit of the present invention is to promote stimulation, nutrition, and abiotic stress reduction together with integrated management of pests, weeds and disease to promote synergies that translate into greater increases in yield and crop quality. Moreover, the present method provides more profits for the growers, supports sustainable agriculture, as well as meeting evolving food chain requirements.

Further advantages of the present method include providing solutions to new age problems like growing food demand, climate change, and limited resources. The present method also preserves the soil and environment to sustain future production.

The present invention provides combinations/compositions and methods of using said compositions which in some aspects at least achieve the above stated objectives.

In an aspect, the present invention provides a method for providing a pesticidal solution comprising applying to a locus an effective amount of at least two components selected from a) an herbicide; b) an insecticide; c) a fungicide; and d) a biostimulant or biocontrol agent.

It may be advantageous to combine one or more components selected from (a) to (c) with at least one biostimulant or biocontrol agent.

In an embodiment, the method comprises applying concurrently or subsequently or sequentially at least one component selected from a) to c) and at least one biostimulant or biocontrol agent to plants or a part or locus thereof.

In an embodiment, the method comprises applying concurrently or subsequently or sequentially at least two components each selected from a) to c) and at least one biostimulant or biocontrol agent to a plant or a part or locus thereof.

In an embodiment, the method comprises applying concurrently or subsequently or sequentially, a component selected from at least one from the group of an herbicide, an insecticide, a fungicide, and a second component selected from a biostimulant or a biological control agent to the plant or a part of locus thereof.

In an embodiment, the method comprises applying concurrently or subsequently or sequentially, an herbicide, an insecticide and a biostimulant or a biological control agent to the plant or a part or locus thereof.

In an embodiment, the present method comprises a first application of a biostimulant and a second application of at least one component selected from a) to c) with a biostimulant or biocontrol agent, simultaneously to the plant or a part or locus thereof for effective control of weeds, fungus and insects, and stimulating plant health and promoting nutrition of the plant.

In an embodiment, the method comprises first applying at least one component selected from a) to c) concurrently or subsequently or sequentially and second applying a biostimulant, simultaneously to the plant or a part or locus thereof for effective control of weeds, fungus and insects.

In an embodiment, the method comprises first applying at least one component selected from a) to c) preferably an herbicide concurrently or subsequently or sequentially and second applying a biostimulant, simultaneously to the plant or a part or locus thereof for effective control of weeds.

In an embodiment, the method comprises first applying at least one component selected from a) to c) preferably a fungicide concurrently or subsequently or sequentially and second applying a biostimulant, simultaneously to the plant or a part or locus thereof for effective control of phytopathogenic fungus.

In an embodiment, the method comprises first applying at least one component selected from a) to c) preferably an insecticide concurrently or subsequently or sequentially and second applying a biostimulant, simultaneously to the plant or a part or locus thereof for effective control of target insects.

In an embodiment, the method comprises first applying at least two components selected from a) to c) preferably an herbicide and an insecticide or herbicide and fungicide or insecticide and fungicide, concurrently or subsequently or sequentially and second applying a biostimulant, simultaneously to the plant or a part or locus thereof for effective control of weeds, fungus or insects and stimulating plant health and promoting nutrition of the plant.

In an embodiment, the method comprises applying two or more components selected from a) to c) concurrently or subsequently or sequentially and an applying a biostimulant, simultaneously to the plant or a part or locus thereof for effective control of weeds, fungus or insects and stimulating plant health and promoting nutrition of the plant.

Accordingly, the present invention provides an integrated pest management strategy, in particular a method for protecting plants and any parts thereof.

The present invention provides various methods as per the crop development need or a specific stage development of the crop, to increases yield and enhance resistance level in crops by ensuring effective growth regulation. The present invention provides conventional crop product combinations and compositions and methods for reducing the damage of plants and plant parts as well as losses in harvested fruits or vegetables caused by insects, nematodes or phytopathogens and which have fungicidal or nematicidal or insecticidal activity.

In addition to the herbicidal, fungicidal or nematicidal or insecticidal synergistic activity, the active compound combinations according to the invention have further surprising properties which, in a wider sense, may also be called synergistic, such as, for example: broadening of the activity spectrum to other weeds, insects, nematodes or phytopathogens, for example to resistant strains of plant diseases; lowering application rates of the active compound combination; sufficient control of weeds, pests with the aid of the active compound combinations according to the invention even at application rates where the individual compounds show no or virtually no activity; advantageous behaviour during formulation or during use, for example during grinding, sieving, emulsifying, dissolving or dispensing; improved storage stability and light stability; advantageous residue formation; improved toxicological or ecotoxicological behaviour; improved properties of the plant so called plant physiology effects, for example better growth, increased harvest yields, a better developed root system, a larger leaf area, greener leaves, stronger shoots, less seed required, lower phytotoxicity, mobilization of the defence system of the plant, good compatibility with plants.

For example, the use of the active pesticide compound combinations or compositions along with biostimulant for cereal crop protection according to the invention contributes considerably to keeping young cereal stands healthy, which increases, for example, the winter survival of the cereal seed treated, and also safeguards quality and yield. Moreover, the present method comprising integrated product combinations according to the invention may contribute to enhanced systemic action. Even if the individual compounds of the combination have no sufficient systemic properties, the active compound combinations according to the invention may still have this property.

The active compounds or active compound combinations of the invention are suitable for protecting plants and plant organs, for increasing the harvest yields, for improving the quality of the harvested material. They may be preferably employed as crop protection agents. They are active against normally sensitive and resistant species and against all or some stages of development.

As already mentioned above, it is possible to treat all plants and their parts according to the invention. In a preferred embodiment, wild plant species and plant cultivars, or those obtained by conventional biological breeding methods, such as crossing or protoplast fusion, and parts thereof, can also be treated.

Depending on the plant species or plant cultivars, their location and growth conditions (soils, climate, vegetation period, diet), the treatment according to the invention may also result in super-additive or synergistic effects. Thus, for example, reduced application rates or a widening of the activity spectrum or an increase in the activity of the active compound combinations and compositions which can be used according to the invention, better plant growth, increased tolerance to high or low temperatures, increased tolerance to drought or to water or soil salt content, increased flowering performance, easier harvesting, accelerated maturation, higher harvest yields, bigger fruits, larger plant height, greener leaf color, earlier flowering, higher quality or a higher nutritional value of the harvested products, higher sugar concentration within the suits, better storage stability or processability of the harvested products are possible, which exceed the effects which were actually to be expected.

The methods, combinations or compositions utilized in the method according to the present invention are now described in detail:

In an embodiment the method of present invention comprising combination of biostimulant and a pesticide selected from an herbicide, fungicide, insecticide, nematocide, acaricide, or combinations thereof, are useful to promote stimulation and provide nutrition to the plant or a part thereof.

In an embodiment the insecticide, is selected from group of acetylcholinesterase (AChE) inhibitors, GABA-gated chloride channel blockers, sodium channel modulators, nicotinic acetylcholine receptor (nAChR) competitive modulators, nicotinic acetylcholine receptor (nAChR) allosteric modulators—Site I, glutamate-gated chloride channel (GluCl) allosteric modulators, Juvenile hormone mimics, miscellaneous nonspecific (multi-site) inhibitors, chordotonal organ TRPV channel modulators, mite growth inhibitors affecting CHS1, microbial disruptors of insect midgut membranes, inhibitors of mitochondrial ATP synthase, uncouplers of oxidative phosphorylation via disruption of the proton gradient, nicotinic acetylcholine receptor (nAChR) channel blockers, inhibitors of chitin biosynthesis affecting CHS1; inhibitors of chitin biosynthesis, type 1, moulting disruptors, dipteran, ecdysone receptor agonists, octopamine receptor agonists, mitochondrial complex III electron transport inhibitors, mitochondrial complex I electron transport inhibitors, voltage-dependent sodium channel blockers, inhibitors of acetyl CoA carboxylase, mitochondrial complex IV electron transport inhibitors, mitochondrial complex II electron transport inhibitors, ryanodine receptor modulators, chordotonal organ modulators—undefined target site, GABA-gated chloride channel allosteric modulators, baculoviruses, nicotinic acetylcholine receptor (nAChR) allosteric modulators—Site II, compounds of unknown or uncertain MoA, UNB* bacterial agents (nonBt) of unknown or uncertain MoA, UNE* botanical essence including synthetic, extracts and unrefined oils with unknown or uncertain MoA, UNF* fungal agents of unknown or uncertain MoA, UNM* non-specific mechanical disruptors.

In an embodiment acetylcholinesterase (AChE) inhibitors may be selected from the classes of carbamates or organophosphates.

Carbamates are selected from Alanycarb, Aldicarb, Bendiocarb, Benfuracarb, Butocarboxim, Butoxycarboxim, Carbaryl, Carbofuran, Carbosulfan, Ethiofencarb, Fenobucarb, Formetanate, Furathiocarb, Isoprocarb, Methiocarb, Methomyl, Metolcarb, Oxamyl, Pirimicarb, Propoxur, Thiodicarb, Thiofanox, Triazamate, Trimethacarb, XMC, and Xylylcarb.

Organophosphate are selected from Acephate, Azamethiphos, Azinphos-ethyl, Azinphosmethyl, Cadusafos, Chlorethoxyfos, Chlorfenvinphos, Chlormephos, Chlorpyrifos, Chlorpyrifos-methyl, Coumaphos, Cyanophos, Demeton-S-methyl, Diazinon, Dichlorvos/DDVP, Dicrotophos, Dimethoate, Dimethylvinphos, Disulfoton, EPN, Ethion, Ethoprophos, Famphur, Fenamiphos, Fenitrothion, Fenthion, Fosthiazate, Heptenophos, Imicyafos, Isofenphos, Isopropyl O-(methoxyaminothio-phosphoryl) salicylate, Isoxathion, Malathion, Mecarbam, Methamidophos, Methidathion, Mevinphos, Monocrotophos, Naled, Omethoate, Oxydemeton-methyl, Parathion, Parathion-methyl, Phenthoate, Phorate, Phosalone, Phosmet, Phosphamidon, Phoxim, Pirimiphos-methyl, Profenofos, Propetamphos, Prothiofos, Pyraclofos, Pyridaphenthion, Quinalphos, Sulfotep, Tebupirimfos, Temephos, Terbufos, Tetrachlorvinphos, Thiometon, Triazophos, Trichlorfon, and Vamidothion.

GABA-gated chloride channel blockers is selected from Chlordane, Endosulfan, Ethiprole, and Fipronil.

Sodium channel modulators may be selected from Pyrethroids, DDT and Methoxychlor. Pyrethroid are selected from Acrinathrin, Allethrin, d-cis-trans Allethrin, d-trans Allethrin, Bifenthrin, Bioallethrin, Bioallethrin Scyclopentenyl isomer, Bioresmethrin, Cycloprothrin, Cyfluthrin, beta-Cyfluthrin, Cyhalothrin, lambdaCyhalothrin, gamma-Cyhalothrin, Cypermethrin, alpha-Cypermethrin, beta-Cypermethrin, thetacypermethrin, zeta-Cypermethrin, Cyphenothrin, (1R)-trans-isomers], Deltamethrin, Empenthrin (EZ)-(1R)-isomers], Esfenvalerate, Etofenprox, Fenpropathrin, Fenvalerate, Flucythrinate, Flumethrin, tau-Fluvalinate, Halfenprox, Imiprothrin, Kadethrin, Permethrin, Phenothrin [(1R)-trans-isomer], Prallethrin, Pyrethrins (pyrethrum), Resmethrin, Silafluofen, Tefluthrin, Tetramethrin, Tetramethrin [(1R)-isomers], Tralomethrin, and Transfluthrin.

Nicotinic acetylcholine receptor (nAChR) competitive modulators may be selected from Neonicotinoids, Nicotine, Sulfoxaflor, Flupyradifurone, and Triflumezopyrim.

Neonicotinoids may be selected from Acetamiprid, Clothianidin, Dinotefuran, Imidacloprid, Nitenpyram, Thiacloprid, and Thiamethoxam.

Nicotinic acetylcholine receptor (nAChR) allosteric modulators—Site I are selected from Spinosyns such as Spinetoram and Spinosad.

Glutamate-gated chloride channel (GluCl) allosteric modulators may be selected from Abamectin, Emamectin benzoate, Lepimectin, and Milbemectin.

Juvenile hormone mimics are selected from Hydroprene, Kinoprene, Methoprene, Fenoxycarb and Pyriproxyfen.

Miscellaneous nonspecific (multi-site) inhibitors may be selected from Methyl bromide and other alkyl halides, Chloropicrin, Cryolite (Sodium aluminum fluoride), Sulfuryl fluoride, Borax, Boric acid, Disodium octaborate, Sodium borate, Sodium metaborate, Tartar emetic, Dazomet, and Metam.

Chordotonal organ TRPV channel modulators may be selected from Pymetrozine, Pyrifluquinazon, and Afidopyropen.

Mite growth inhibitors affecting CHS1 may be selected from Clofentezine, Diflovidazin, Hexythiazox and Etoxazole.

Microbial disruptors of insect midgut membranes may be selected from Bacillus thuringiensis subsp. Israelensis, Bacillus thuringiensis subsp. Aizawai, Bacillus thuringiensis subsp. Kurstaki, Bacillus thuringiensis subsp., and Bacillus sphaericus.

Inhibitors of mitochondrial ATP synthase may be selected from Diafenthiuron, Azocyclotin, Cyhexatin, Fenbutatin oxide, Propargite, and Tetradifon.

Uncouplers of oxidative phosphorylation via disruption of the proton gradient may be selected from Chlorfenapyr DNOC Sulfluramid

Nicotinic acetylcholine receptor (nAChR) channel blockers may be selected from Bensultap, Cartap hydrochloride, Thiocyclam, and Thiosultap-sodium.

Inhibitors of chitin biosynthesis affecting CHS1 may be selected from Bistrifluron, Chlorfluazuron, Diflubenzuron, Flucycloxuron, Flufenoxuron, Hexaflumuron, Lufenuron, Novaluron, Noviflumuron, Teflubenzuron, and Triflumuron.

Inhibitors of chitin biosynthesis, type 1 may be selected from Buprofezin.

Moulting disruptors, Dipteran may be selected from Cyromazine.

Ecdysone receptor agonists may be selected from Chromafenozide, Halofenozide, Methoxyfenozide, and Tebufenozide.

Octopamine receptor agonists may be selected from Amitraz.

Mitochondrial complex III electron transport inhibitors may be selected from Hydramethylnon, Acequinocyl, Fluacrypyrim, and Bifenazate.

Mitochondrial complex I electron transport inhibitors may be selected from Fenazaquin, Fenpyroximate, Pyridaben, Pyrimidifen, Tebufenpyrad, Tolfenpyrad and Rotenone (Derris).

Voltage-dependent sodium channel blockers may be selected from Indoxacarb and Metaflumizone.

Inhibitors of acetyl CoA carboxylase may be selected from Spirodiclofen, Spiromesifen, Spiropidion, and Spirotetramat.

Mitochondrial complex IV electron transport inhibitors may be selected from Aluminium phosphide, Calcium phosphide, Phosphine, Zinc phosphide, Calcium cyanide, Potassium cyanide, and Sodium cyanide.

Mitochondrial complex II electron transport inhibitors may be selected from Cyenopyrafen, Cyflumetofen and Pyflubumide.

Ryanodine receptor modulators may be selected from Chlorantraniliprole, Cyantraniliprole, Cyclaniliprole Flubendiamide, Tetraniliprole, and the like.

Chordotonal organ Modulators—undefined target site may be selected from Flonicamid.

GABA-gated chloride channel allosteric modulators may be selected from Broflanilide or Fluxametamide.

Baculoviruses may be selected from Cydia pomonella GV, Thaumatotibia leucotreta GV, Anticarsia gemmatalis MNPV, and Helicoverpa armigera NPV.

Nicotinic Acetylcholine Receptor (nAChR) Allosteric Modulators—Site II may be selected from GS-omega/kappa HXTX-Hvla peptide.

The compounds of unknown or uncertain mechanism of action (MoA) may be selected from Azadirachtin, Benzoximate, Bromopropylate, Chinomethionat, Dicofol, Lime sulfur, Mancozeb, Pyridalyl and Sulfur.

The bacterial agents (nonBt) of unknown or uncertain MoA may be selected from Burkholderia spp and Wolbachia pipientis (Zap).

The botanical essence including synthetic, extracts and unrefined oils with unknown or uncertain MoA may be selected from Chenopodium ambrosioides near ambrosioides extract Fatty acid monoesters with glycerol or propanediol Neem oil.

In another embodiment, the insecticide used include, Metofluthrin, Flubendiamide, Pyrifluquinazon, Chlorantraniliprole, Cyantraniliprole, Spinetoram, Metaflumizone, Spirotetramat, Sulfoxaflor, Tetraniliprole, Afidopyropen, Broflanilide, Fluxametamide, Spiropidion, Flometoquin, Triflumezopyrim, Acynonapyr, Flupyrimin, Lepimectin, Bacillus firmus strain 1-1582, Fluensulfone, Momfluorothrin, Flupyradifurone, Pyflubumide and Cyclaniliprole.

In an embodiment, the fungicide may be selected from nucleic acid synthesis inhibitors, cytoskeleton and motor protein inhibitors, amino acids and protein synthesis inhibitors, respiration process inhibitors, signal transduction inhibitors, lipid synthesis or transport and membrane integrity disruptors or functions, sterol biosynthesis inhibitors, melanin synthesis inhibitors, cell wall biosynthesis inhibitors, melanin synthesis inhibitor in cell wall, host plant defence inductors, fungicides with unknown modes of action, non-classified fungicides, fungicides with multisite activity and/or biologicals with multiple mode of action.

Thus, in an embodiment, the nucleic acid synthesis inhibitor fungicides may be selected from acylalanines such as benalaxyl, benalaxyl-M (kiralaxyl), furalaxyl, metalaxyl, metalaxyl-M (mefenoxam), oxazolidinones such as oxadixyl, butyrolactones such as ofurace, hydroxy-(2-amino-) pyrimidines such as bupirimate, dimethirimol, ethirimol, isoxazoles such as hymexazole, isothiazolones such as octhilinone, carboxylic acids such as oxolinic acid.

In an embodiment, the cytoskeleton and motor protein inhibitors may be benzimidazoles such as benomyl, carbendazim, fuberidazole, thiabendazole, thiophanates such as thiophanate, thiophanate-methyl, N-phenyl carbamates such as diethofencarb, toluamides such as zoxamide, thiazole carboxamides such as ethaboxam, phenylureas such as pencycuron, benzamides such as fluopicolide and fluopimomide, cyanoacrylates such as phenamacril; aryl-phenylketones such as metrafenone and pyriofenone.

In an embodiment, the respiration process inhibitor fungicides may be selected from pyrimidinamines such diflumetorim, pyrazole-5-carboxamides such as tolfenpyrad, quinazoline such as fenazaquin; SDHI such as benodanil, flutolanil, mepronil, isofetamid, fluopyram, fenfuram, carboxin, oxycarboxin, thifluzamide, benzovindiflupyr, bixafen, fluindapyr, fluxapyroxad, furametpyr, inpyrfluxam, isopyrazam, penflufen, penthiopyrad, sedaxane, isoflucypram, pydiflumetofen, boscalid and pyraziflumid; strobilurins such as azoxystrobin, coumoxystrobin, enoxastrobin, flufenoxystrobin, picoxystrobin, pyraoxystrobin, mandestrobin, pyraclostrobin, pyrametostrobin, triclopyricarb, kresoxim-methyl, dimoxystrobin, fenaminostrobin, famoxadone, metominostrobin, trifloxystrobin, famoxadone, fluoxastrobin, fenamidone, pyribencarb and mixtures thereof, imidazolinones such as fenamidone; benzyl-carbamates such as pyribencarb; N-methoxy-(phenyl-ethyl)-pyrazole-carboxamides such as Pyrimidinamines such as diflumetorim, cyano-imidazole such as cyazofamid, sulfamoyl-triazole such as amisulbrom, picolinamides such as fenpicoxamid dinitrophenyl crotonates such as binapacryl, meptyldinocap, dinocap, 2,6-dinitro-anilines such as fluazinam, pyr.-hydrazones such as ferimzone, tri-phenyl tin compounds such as fentin acetate, fentin chloride, fentin hydroxide, thiophene-carboxamides such as silthiofam, triazolo-pyrimidylamine such as ametoctradin; anilino-pyrimidines such as cyprodinil, mepanipyrim, pyrimethanil or their isomers.

In another embodiment the fungicides used include Metrafenone, Amisulbrom, Isotianil, Fluopicolide, Fenpyrazamine, Valifenalate, Mandipropamid, Penflufen, Bixafen, Fluopyram, Fluxapyroxad, Isopyrazam, Penthiopyrad, Pyriofenone, Sedaxane, Pydiflumetofen, Dichlobentiazox, Isoflucypram, Fenpicoxamid, Florylpicoxamid, Fluoxapiprolin, Mefentrifluconazole, Ipfentrifluconazole, Metyltetraprole, Inpyrfluxam, Quinofumelin, Oxathiapiprolin, Fluindapyr, Dipymetitrone, Pyridachlometyl, Benzovindiflupyr, Orysastrobin, Ametoctradin, Flutianil, Pyraziflumid, Coumoxystrobin, Pyribencarb, Tebufloquin, Isofetamid, Tolprocarb, Mandestrobin and Picarbutrazox.

In an embodiment, amino acids and protein synthesis inhibitor fungicides may be selected from anilino-pyrimidines such as cyprodinil, mepanipyrim, pyrimethanil, antibiotic fungicides such as blasticidin-S, kasugamycin, streptomycin, oxytetracycline, and the like.

In an embodiment, signal transduction inhibitor fungicides may be selected from aryloxyquinolines such as quinoxyfen, quinazolinones such as proquinazid, phenylpyrroles such as fenpiclonil, fludioxonil, dicarboximides such as chlozolinate, dimethachlone, iprodione, procymidone, and vinclozolin.

In an embodiment, the fungicide may be selected from lipid synthesis and membrane integrity distruptors such as phosphoro-thiolates such as edifenphos, iprobenfos, pyrazophos, dithiolanes such as isoprothiolane, aromatic hydrocarbons such as biphenyl, chloroneb, dicloran, quintozene (PCNB), tecnazene (TCNB), tolclofos-methyl and the like, 1,2,4-thiadiazoles such as etridiazole, carbamates such as iodocarb, propamocarb, prothiocarb and the like. Further, microbial disrupters of pathogen cell membranes such as Bacillus amyloliquefaciens strain QST 713, Bacillus amyloliquefaciens strain FZB24, Bacillus amyloliquefaciens strain MBI600, Bacillus amyloliquefaciens strain D747 (synonyms for Bacillus amyloliquefaciens are Bacillus subtilis and B. subtilis var. amyloliquefaciens); cell membrane disruption such as extract from Melaleuca alternifolia (tea tree); plant oils (mixtures): eugenol, geraniol, thymol, carvacrol; ergosterol binding such as natamycin (pimaricin) piperidinyl-thiazoleisoxazolines such as oxathiapiprolin

In an embodiment, the sterol biosynthesis inhibitors may be selected from triazoles such as azaconazole, bitertanol, bromuconazole, cyproconazole, difenoconazole, diniconazole, etaconazole, fenbuconazole, fluquinconazole, flusilazole, flutriafol, hexaconazole, imibenconazole, Ipconazole, metconazole, myclobutanil, penconazole, propiconazole, simeconazole, tebuconazole, tetraconazole, triadimefon, triadimenol, triticonazole, prothioconazole, piperazines such as triforine, pyridines such as pyrifenox, pyrisoxazole, pyrimidines such as fenarimol, nuarimol imidazoles such as imazalil, oxpoconazole, pefurazoate, prochloraz, triflumizole, morpholines such as aldimorph, dodemorph, fenpropimorph, tridemorph and the like, piperidines such as fenpropidin, piperalin, spiroketal-amines such as spiroxamine, hydroxyanilides such as fenhexamid, amino-pyrazolinones such as fenpyrazamine, thiocarbamates such as pyributicarb, allylamines such as naftifine, terbinafine, and mixtures thereof.

In an embodiment, cell wall biosynthesis inhibitor fungicides may be selected from peptidyl pyrimidine nucleoside fungicides such as polyoxin, cinnamic acid amides such as dimethomorph, flumorph, pyrimorph, valinamide carbamates such as benthiavalicarb, iprovalicarb, valifenalate, mandelic acid amides such as mandipropamid, and mixtures thereof.

In an embodiment, melanin synthesis inhibitor fungicide may be selected from isobenzo-furanone such as thalide, pyrrolo-quinolinones such as pyroquilon, triazolobenzo-thiazoles such as tricyclazole, cyclopropane-carboxamides such as carpropamid, carboxamides such as diclocymet, propionamides such as fenoxanil, trifluoroethyl-carbamates such as tolprocarb, and mixtures thereof.

In an embodiment, host plant defence inductors fungicides may be selected from benzo-thiadiazoles such as acibenzolar-S-methyl, benzisothiazoles such as probenazole, thiadiazole-carboxamides such as tiadinil, isotianil, polysaccharides such as laminarin, and mixtures thereof; complex mixture, ethanol extract (anthraquinones, resveratrol) such as Reynoutria sachalinensis (giant knotweed) bacterial Bacillus spp. such as Bacillus mycoides isolate; fungal Saccharomyces spp such as cell walls of Saccharomyces cerevisiae strain; ethyl phosphonates such as fosetyl-Al phosphorous acid and salts.

In an embodiment, the fungicide may be one with an unknown mode of action and may be selected from cyanoacetamide-oximes such as cymoxanil, ethyl phosphonates such as foestyl, phophorous acid and salts, phthalamic acids such as teclofthalam, benzotriazines such as triazoxide, benzene-sulphonamides such as flusulfamide, pyridazinones such as diclomezine, thiocarbamates such as methasulfocarb, phenyl-acetamides such as cyflufenamid, aryl-phenylketones such as metrafenone, pyriofenone, guanidines such as dodine, cyano-methylene-thiazolidines such as flutianil, pyrimidinone-hydrazones such as ferimzone, piperidinyl-thiazole-isoxazolines such as oxathiapiprolin, 4-quinolyl-acetates such as tebufloquin, tetrazolyloximes such as picarbutrazox, glucopyranosyl antibiotics such as validamycin, fungicides such as mineral oil, organic oils, potassium bicarbonate, cinnamon oil, orange oil, cinnamaldehyde, carvacrol, or mixtures thereof.

In an embodiment, the fungicide may be chemicals with multi-site activity selected from the group consisting of dithiocarbamates, phthalimides, chloronitriles, inorganic fungicides, sulfamides, bis-guanidines, triazines, quinones, quinoxalines, maleimide, and mixtures thereof.

In an embodiment, the multi-site fungicide is selected from the class of dithiocarbamate fungicides selected from asamobam, asomate, azithiram, carbamorph, cufraneb, cuprobam, disulfiram, ferbam, metam, nabam, tecoram, thiram, urbacide, ziram, dazomet, etem, milneb, mancopper, mancozeb, maneb, metiram, polycarbamate, propineb, and zineb.

In an embodiment, the multi-site fungicide is a phthalimide fungicide selected from captan, captafol, and folpet.

In an embodiment, the multi-site fungicide is a chloronitrile fungicide such as chlorothalonil.

In an embodiment, the multi-site fungicide is a sulfamide fungicide selected from dichlofluanid and tolylfluanid.

In an embodiment, the multi-site fungicide is a bis-guanidine fungicide selected from guazatine and iminoctadine.

In an embodiment, the multi-site fungicide is a triazine fungicide selected from anilazine.

In an embodiment, the multi-site fungicide is a quinone fungicide selected from dithianon.

In an embodiment, the multi-site fungicide is a quinoxaline fungicide selected from quinomethionate and chlorquinox.

In an embodiment, the multi-site fungicide is a maleimide fungicide selected from fluoroimide.

In an embodiment, the multi-site fungicide is an inorganic fungicide selected from copper fungicides including copper (II) hydroxide, copper oxychloride, copper (II) sulfate, basic copper sulfate, Bordeaux mixture, copper salicylate, cuprous oxide, or sulphur.

In another embodiment, the ergosterol biosynthesis inhibitors may be selected from prothioconazole, tebuconazole, hexaconazole, cyroconazole, or epoxiconazole.

In an embodiment, the fungicide may be a Quinone outside (Qo) inhibitor fungicide selected from azoxystrobin, coumoxystrobin, enoxastrobin, flufenoxystrobin, picoxystrobin, pyraoxystrobin, mandestrobin, pyraclostrobin, pyrametostrobin, triclopyricarb, kresoxim-methyl, dimoxystrobin, fenaminostrobin, metominostrobin, trifloxystrobin, famoxadone, fluoxastrobin, fenamidone, pyribencarb, and mixtures thereof.

In an embodiment, the Quinone outside (Qo) inhibitor fungicide may be selected from azoxystrobin, picoxystrobin, kresoxim-methyl, pyraclostrobin, and trifloxystrobin.

In an embodiment, the herbicide may be selected from a isoxazolidinone herbicide, a urea herbicide, a triazine herbicide, a hydroxybenzonitrile herbicide, a thiocarbamate herbicide, a pyridazine herbicide, chloroacetanilide herbicides; benzothiazole herbicides; carbanilate herbicides, cyclohexene oxime herbicides; picolinic acid herbicides; pyridine herbicides; quinolinecarboxylic acid herbicides; chlorotriazine herbicides, aryloxyphenoxypropionic herbicides, oxadiazolone herbicides; phenylurea herbicides, sulfonanilide herbicides; triazolopyrimidine herbicides, amide herbicides, pyridazine herbicides, dinitroaniline herbicides, or combinations thereof.

In yet another embodiment the herbicide is selected from an amide herbicide such as allidochlor, amicarbazone, beflubutamid, benzadox, benzipram, bromobutide, cafenstrole, cafentrazone, cafentrazone-ethyl, cyprazole, dimethenamid, dimethenamid-P, diphenamid, epronaz, etnipromid, fentrazamide, flucarbazone, flupoxam, fomesafen, halosafen, huangcaoling, isocarbamid, isoxaben, napropamide, napropamide-M naptalam, pethoxamid, propyzamide, quinonamid, saflufenacil, tebutam, tiafenacil, sulfonamide herbicide such as asulam, carbasulam, fenasulam, oryzalin, penoxsulam, pyroxsulam, aryloxycarboxylic acids such as MCPA-thioethyl, aryloxyphenoxypropionates such as clodinafop-propargyl, cyhalofop-butyl, diclofops, fluazifops, haloxyfops and its esters, haloxyfop-P and its esters, quizalofops, chloroacetamides such as acetolochlor, alachlor, butachlor, dimethenamid, metolachlor, S-metolachlor, propachlor, cyclohexanedione oximes such as alloxydim, butroxydim, clethodim, cloproxydim, cycloxydim, profoxydim, sethoxydim, tepraloxydim, tralkoxydim, benzamides such as isoxaben, benzoic acid derivatives such as dicamba, ethofumesate, dinitroanilines such as benfluralin, butralin, chlornidine, dinitramine, dipropalin, ethalfluralin, fluchloralin, isopropalin, methalpropalin, nitralin, oryzalin, pendimethalin, prodiamine, profluralin, trifluralin, diphenyl ethers such acifluorfen, aclonifen, bifenox, chlomethoxyfen, chlornitrofen, etnipromid, fluorodifen, fluoroglycofen, fluoronitrofen, fomesafen, fucaomi, furyloxyfen, halosafen, lactofen, nitrofen, nitrofluorfen, oxyfluorfen, organophosphorus herbicides such as glufosinate, L-glufosinate or its salt and glyphosate, hydroxybenzonitriles such as bromoxynil, imidazolinones such as fenamidone, imazapic, imazamox, imazapic, imazapyr, imazethapyr, imazaquin, isoxazolidinones such as clomazone paraquat as bypyridylium, phenyl carbamates such as desmedipham, phenmedipham, phenylpyrazoles such as pyraflufen-ethyl, phenylpyrazolines such as pinoxaden, pyridinecarboxylic acids or synthetic auxins such as picloram, clopyralid, and triclopyr, pyrimidinyloxybenzoics such as bispyrtbac-sodium, sulfonylureas such as amidosulfuron, azimsulfuron, bensulfuron-methyl, chlorsulfuron, chlorimuron, cyclosulfamuron, ethoxysulfuron, flazasulfuron, flucetosulfuron, flupyrsulfuron, foramsulfuron, halosulfuron, imazosulfuron, mesosulfuron, metsulfuron-methyl, methiopyrisulfuron, monosulfuron, nicosulfuron, orthosulfamuron, oxasulfuron, primisulfuron, propyrisulfuron, pyrazosulfuron, rimsulfuron, sulfometuron, sulfosulfuron trifloxysulfuron, flazasulfuron, foramsulfuron, flupyrsulfuron-methyl-sodium, nicosulfuron, rimsulfuron, sulfosulfuron, tribenuron-methyl, trifloxysurlfuron-sodium, triflusulfuron, tritosulfuron, triazolopyrimidines such as penoxsulam, metosulam, florasulam, triketones such as mesotriones, sulcotrione, ureas such as diuron, linuron, phenoxycarboxylic acids such as 2,4-D, MCPA, MCPB, mecoprops and triazines such as atrazine, simazine, and terbuthylazine.

In another embodiment the herbicides used in present invention include, Topramezone, Metamitron, Metribuzin, Orthosulfamuron, Pinoxaden, Metamifop, Pyrimisulfan, Tembotrione, Thiencarbazone methyl, Flucetosulfuron, Aminopyralid, Pyrasulfotole, Saflufenacil, Pyroxsulam, Pyroxasulfone, Pyraclonil, Indaziflam, Fenquinotrione, Florpyrauxifen-benzyl, Tiafenacil, Cinmethylin, Lancotrione-Sodium, Bixlozone, Trifludimoxazin, Cyclopyrimorate, Methiozolin, Aminocyclopyrachlor, Metazosulfuron, Ipfencarbazone, Fenoxasulfone, Bicyclopyrone, Triafamone, Halauxifen methyl, and Tolpyralate.

In one embodiment, the compositions of the present invention comprise a combination of a biostimulant and at least one pesticide of interest of the herbicidal type.

In one embodiment the compositions used to promote the plant health and reduce crop damage can comprise at least one herbicide selected from the group of active ingredients: (2,4-D), (2,4-D+picloram), (2,4 (Gibberellic acid+benzyladenine), (acifluorfemodic), (acifluorfemodic+bentazone), (acifluorfem sodium+bentazone), (acifluorfemodic acid+gibberellic acid+kinetin), acellifen), (alachlor+atrazine), alachlor+trifluralin), (aloxidim), (ametrine), (ametrine+clomazone), (ametrine+diurom), (ametrine+diurom+MCPA), (amicarbazone+flumioxazin), (amicarbazone+flazasulfurom), (amicarbazone+hexazinone+diuron), (amicarbazone+clomazone), (amicarbazone+flumioxazin), (ametrine+trifloxysulfuron-(aminopyralide), (aminopyralid+2,4-D), (aminopyralide+fluroxypyr-methyl), (aminosulfuron), (amitraz), (atrazine+nicosulfur), (atrazine+glyphosate), (atrazine+nicosulfuron), (atrazine+glyphosate), (atrazine+S-metolachlor), (atrazine+simazine), (bentazone+imazamox), (bentazone+paraquate), (benzamide), (pyrimidinyl benzoate), (bentazone+imazamox), benzenesulfuron, (benzofenap), (benzofuran), (bromocycline+diurom), (methyl bromide), (bromoxynil), (buquitrila), (butachlor), (butachlor), (butafenacyl), (butylated), (butroxydim), (carbetamide), (ethyl carfentrazone), ethyl carfetrazone+clomazone, (cyanofopbutyl), (cyanazine), (cycloate), (cycloxydim), (cinimethyltin), (clethodim+fenoxaprope-P-ethyl), (clethodim+haloxyfop methyl, (clethodim+quizalofop p-ethylic), (clodinafop-propargyl), (clomazone), (clopyralid), (chloransulam-methyl), (mepiquate chloride), (chlorimuromethyl), (chlorotolurom), (chlorosulfuron), (dazomete), (decanol), (DCPA), (desmedipham), (demethrin), (devrinola), (dicamba), (dichlobenyl), (dichloroprop), (diclophope), (diclosulam), (difenzoquate), (diflufenicam), (diflufenzopyr), (dimfurom), (diurom+glyphosate), (diurom+hexazinone), (diurom+MSMA), (dihrom+hexaminone), (diurom+paraquate), (diurom+sulfentrazone), (diurom+thidiazurom), (diurom+tebutiurom), (DSMA), (endotal), (EPTC), (esprocarb), eththalfluralin), (etametisulfurom) (etophon+cyclanilide), etophon+glufosinate ammonium salt), ethofumesate, ethoxysulfuron, fenemedifam, fenoxaprope-P-ethylic, fentrazamide, flazassulfuron, (flufenpyrone), (flufenpyr-ethyl), (flumetralin), (flumetsulam), (flumicloraque pentyl), (flumioxazine), (fluometurono), (fluoroglycofen), (flupyrsulfuron-methylic sodium), (Fluorocloridone), (fluridone), (fluroxypyr-methyl), (fluroxypyr-methyl+picloram), (fluroxypyr-methyl+trichlopy butyloxy), (flutarmone), (fluoromethyl), (fomesafem), (foramsulfuron), (foranesulfuron+iodosulfuron-methyl), glyphosate+2,4-D), (glyphosate+cafentrazone-ethyl), (glyphosate+simazine), (glufosinate-ammonium salt), (halosulfuromethyl), (haloxyfop-β-methyl), (hexazinone), (hexazinone+sulfometurom-methyl), (maleic hydrazide), Imazametabenzo, (imazamyx), (imazapique), (imazapique+imazapyr), (imazapique+imazethapyr), (imazapyr), (imazethapyr+glyphosate), (indaziflam+isoxaflutole), (indaziflam+metribuzin), (imazethapyr+glyphosate), (imazethapyr+glyphosate), (imazethapyr+glyphosate) (iodosulfuron-methyl), (isoproturom), (isoxabem), (methoprene), (methamphelo), (methotrexate), (methotrexate), (methotrexate), (methotrexate), (methotrexate), (metham), (methylcyclopropene), (methylbenzobrom) (metolachlor), (metolachlor+glyphosate), (methoxychrom) (metribuzin), (metsulfuron-methyl), (molinate) (monolinuron), (MSMA), (napropamido), (napitalam) (oxosiloxane) (oxyfluorfen), (paclobutrazol), (paraquate), (pebylate) (pendimethalin), (penoxsulam), (oresulfonuron), (picloram), (Picolinafen) (pyraflufenemethyl), (Pyrazolonate), (pyrazosulfuromethyl), (pyrazole), (pyrazole), (pyrazoxifen) (pyribenzoxim), (pyrazo-sodium), (pyroxsulam) (prohexyl), (prohexadione), (prometrine), (pronamide) (propachlor), (propanyl), (propanyl+triclopyr-butotyl) (propaquizafope), (propazine), (propoxycarbazone) (s-metolachlor glyphosate), (prosulfuron), (prosulfuron), (pyrazol) (quinclorque), (quizalofop-P-ethyl), (saflufenacyl), (ethoxyidim), (sidurom) (sulphometuromethyl) sulphonium methyl sulfosulfuron, terbottromon, tebuthiuron flazasulfuron, (tembotrione), (tepraloxydim), (sulpho-, (terbacyl) (terbuthylazine), (tenylchlor), (thidiazurom), (thiazopyr) (thifensulfuron), (thiobencarb), (tralkoxydim), (triatoate) (triasulfuron), (tribenurom), (triclopyrbutyl) (triclopyr-butoethyl+picloram), (trietazine) (trifloxysulfuron-sodium), (trifluralin), (triflussulfuron) (trinexapaque-ethyl), (vernolate) or combinations thereof.

In one embodiment, the compositions of the present invention containing combination of a biostimulant and at least one pesticide of interest of the fungicidal type.

In one embodiment, the compositions used in the present invention may comprise at least one fungicide selected from the group of active ingredients or combinations thereof: (2-phenylphenol), (8-hydroxyquinoline sulfate), (copper acetate) acetate (acibenzolar-S-methyl), (benzohydroxamic acid), (dehydroacetic acid, (allyl alcohol), (aldimorph), (ampropylphos), (anilazine), (azaconazole), (sodium azide), sodium azide), (azithromycin), (azoxystrobin), (azoxystrobin+benzovindiflupir), (azoxystrobin+cyproconazole), (azoxystrobin+tebuconazole), (azoxystrobin+tetraconazole), (aureofystine), (Bacillus pumulis), (benzoxyl), (benzoxylate), (azoxystrobin+chlorothalonil), (benalaxyl+mancozeb), (benodanyl), (benomyl), (benquinoxy), (bentalurom), (benzapacryl), (benzovindiflupir), (betoxazim), (potassium bicarbonate), (binapacryl), (biphenyl), (bentivalicarb isopropyl), (benthiavalicarb isopropyl)+(chlorothalonyl), (benthiavalicarb isopropyl+fluazinam), (boscalide+dimoxystrobin), (boscalide+pyraclostrobin), (methyl bromide), (bichlorozole), (bichloride+dimoxystrobin), (bupyrimate), (butylobate), (carbendazim+tebuconazole), (carbendazim tetra), (carboxy carbonate), (carboxymethyl) carbamazepine, (carbendazim+tebuconazole), (carbendazim+tebuconazole), (carboxy thiram), (casugamycin), (casinomycin+oxychloride and copper), (cyazofamide), (cycllafuramide), (cyclohexamid) cyproxanil+cytoxanil+cytoxanil+cytoxanil+famoxadone), cyproxanil+mancozebe (cyproendazole), cyproconazole, cyproconazole+diphenoconazole (cyproconazole+propiconazole) (climbazol), (clobentiazone), (benzalkonium chloride) (propamocarb hydrochloride+chloramphenicol), (propamocarb hydrochloride+chloramphenicol), (propamocarb hydrochloride+chloramphenicol), (propamocarb hydrochloride+chloramphenicol), (propamocarb hydrochloride+fluamidolide), (chloramphenol) (chloroniformetan), (chloroneb), (chloronyl), (chloropicrin) (chlorothalonil), (chlorothalonil+methoxyl-M), (chlorothalonil+oxychloride and copper), (chlorothalonil+tebuconazole), (chlorothalonil thiophanate-methyl), (clotrimazole), (clozolinate), (cresol) (crescoxim-methyl), (kresoxim methyl+epoxiconazole) (kresoxim methyl+tebuconazole), (copper chromate zinc), (cufranebo), (cuprobam), (dazomete), (DBCP) (debacarb), (decafentin)), (dichlofluanid) (diclohexine), (diclone), (dichloran), (dichlorophen) (diclozoline), (diclobutrazol), (diethophenocarb) (dinopentom), (dinopentom), (dinopentom), (dinopentom), (dinopentom), (dinopentom), (dinopentom), (dinopentom), (dimethomorph), (dithioterbom) (dipyrithione), (disulfiram), (ditalimphos), (dithianone) (epoxiconazole+pyraclostrobin), (epoxiconazole+pyraclostrobin), (epoxiconazole+pyraclostrobin), (epoxiconazole+thiophanate methyl), (spiroxamine), (streptomycin), (etaconazole), (etaboxam), (etem), (etodolol), (etiidolol), (etirimol), (ethoxyquin), (extract of Melaleuca alternifolia), (extract of Reynoutria sachalinensis), (famoxadone), (famoxadone+mancozeb), (fenamidone), (fenaminosulfa) (fenbuconazole), (fenbuconazol), (fenfuram), (fenhexamid), (fenitopram), (phenoxanil), (fenpropronil), (fenpropidim), (fenpropimorph), (femtim), (ferbam), (ferimzone), (fluazinam), (fludioxonil+metalaxyl-M), (fludioxonil+metalaxyl-M+azoxystrobin), (fluindapyr), (flumetover), (flumorph), (fluopicolide), (fluorimide), (fluoxetrobin+chlorothalonil), (fluoxastrobin+tebuconazole), (flutathione+carbadiazine), (flutamyl+thiamphanate-methyl), (flavolyline), (flavolyline+pyraclostrobin), (flavololate), (flavolonazole), (fosetil), (ferric phosphate), (formaldehyde), (phthalide), (fuberidazole), (furometapyr), (furametapyr), (furcarazolyl), (furconazole), (furconazol-cis), (furmicycloxy), (furophanate), (glyiodim), (griseofulvin), (guazatine), (halacrinate), (hexylthiophos), (isoprothiolane), (isovaledione), (hexaconazole), (imazalil), (imibenconazole), (inhidrofluxam), (ipconazol), (iproazol+thiram), (iprodione), (iprovalicarbe+propinebe), (methyl isothiocyanate), (mancozeb+metalaxyl-M), (mancozeb+copper oxychloride), (mancozeb+thiophanate-methyl), mancozeb+zoxamide), (mandipropamide), (mandipropamide+chlorothalonil), (mancozeb+(metalaxyl-M), (metalaxyl-M+thiabendazole+fludioxonil), (metalaxyl-M+thiabendazole+fludioxonil+thiamethoxam), (sodium methamyl)), (metconazole), (methyram), (methyram+pyraclostrobin), Metominostrobin, (metominostrobin+tebuconazole), (methysulfovaxy), (mepronyl), (metam), (metazoxolom), (metasulfocarb), (metifuroxam), (metraphenone), (nytobutanil), (milbemectin), (milneb), (miclozoline), (nabam), (copper naphthenate), (zinc naphthenate), (natamycin), (nicobifem), (nitrostyrene), nuracil), (octolinone), (ofuraci), (oxystyloxine), (oxyphosphinoxy), (oxadixyl), (oxycarboxine), copper oxide, cuprous oxide, tributyltin oxide, (picoxystrobin+benzop, indiflupir), (picoxystrobin+cyproconazole), (picoxystrobin+tebuconazole), (pentachlorophenol), (pentachlorophenol), (pentachlorophenol), (pyraclostrobin+methyl thiophanate), (pyraclostrobin+methyl thiophanate+fipronil), (pyrazofos), (pyridinitrile), (pyrifyloxy), (pyrimethanyl), (pyrimethanyl)+(iprodione), (pyrocarbonate), (pyroxyl), (piroxyl), (polycarbamate), (polyoxine), (polyoxorim), (polysulfite bicarbonate), polysulfite potassium,), (procymidone), (propiconazole), (propiconazole), (propiconazole), (propiconazole), (propiconazole), (propiconazole), (propiconazole), (propiconazole), (quinazamide), (quinconazole), (quinomethionato), (tetracycline), (tetracycline), (tetracycline), (tetracycline), (tetracycline), (methionine), (thiocyanate), (tetraconazole), (thiabendazole), (tiadifluor), (thadinyl), (thifluzamide), (ticiofen), (potassium thiocyanate), (thiochlorophenyl), (thiophanate methyl), (triadimenfon), (triadimenol), (triadimenol+disulfoton), triadimenol+tebuconazole), (triamiphos), (triarimol), (triazybutyl), (triazoxide), (tricyclazole), (Trichoderma asperellum), (Trichoderma harzianum), (trifloxystrobin+cytoconazole), (trifloxystrobin+propiconazole), (trifloxystrobin+prothioconazole), (trifloxystrobin+(trifloxystrobin+tebuconazole), (triflumizole), (zonamide), (zoxamide), (zoxamide+cymoxanil), (zigoamide), (zigoamide), (valine) and the like.

In one embodiment, the compositions of the present invention can comprise a combination of a biostimulant and at least one pesticide of interest of the insecticidal type.

In one embodiment the compositions in the present invention may comprise at least one insecticide selected from the group of active ingredients or combinations thereof: (1,4-dimethoxybenzene), (4,8-dimethyldecanal), (5,9-dimethylpentadecane), (abamectin), (mite Neoseiulus californicus), (acetate), (acequinoyl), (acetamiprid), (acetamiprid+alpha-cypermethrin), (acetamiprid+biphenyl) acetate (acetamiprid+ethophenproxy), (acetamiprid+fenpropatrin), (acetamiprid+pyriproxyfen), [(E,Z,Z)-3,8,11-tetradecatrienyl acetate], Z-7 acetate (Z)-9,7-tridecadienyl acetate), (Z,E)-9,12-tetradecadienyl acetate, (Z)-9-tetradecenyl acetate+(Z)-9-dodecenyl acetate, (Z)-8-dodecenyl acetate+(E)-8-dodecenyl acetate), (EZ)-3,5-dodecadienyl acetate+(Z)-9 hexadecenyl acetate), ((E,Z)-7,9-dodecadienyl acetate), (E,Z)-3,8-tetradecadienyl acetate+(E,Z,Z) 3,8,11-tetradecatrienyl acetate), ((E)-8-dodecenyl acetate+(Z)-8-dodecenyl acetate, (E)-8-dodecenyl acetate+(Z)-8-dodecenyl acetate+δ-8-dodecenol Acetate (E,Z)-dodecadienyl), (acrinathrin), (alanicarb), (aldicarb), (aldicarb), (alfa-cypermethrin), (alpha-cypermethrin+teflubenzuron), (Bacillus thuringiensis), (Bacillus thuringiensis), (Bacillus sphaericus), (Bacillus sphaericus), (Bacillus sphaericus), (azithromycin), (azaphtyl) (bendiocarbe), (beta-cyfluthrin), (beta-cyfluthrin+triflumuron), (beta-cypermethrin), (beta-cyfluthrin), (beta-cyfluthrin), (beta-cyfluthrin), (bifenthrin+imidacloprid), (bifenthrin+carbosulfan), (bifenthrin+imidacloprid), (bioallethrin), (bistriflurone), (boraxy), (bioresmethrin), (methyl bromide), (buprofezine), (butocarboxine), (butoxycarboxine), (cadetrine), (cadusafos), (carbaryl), (carbofuran), (carbosulfan), (cyanothrin), (cyanide), (cyanophos), (cyanthraniliprole), (cienopirafen), (cyphenothrin), (cypermethrin), (cypermethrin+thiamethoxam), (cyromazine), (clofentezine), (chloradana), (chlorantraniliprole), (cypermethrin+thiamethoxam), (chloranthraniliprole+abamectin), (chlorfenapyr), (chlorfluazurom), (aviglycine hydrochloride), (chlorheteridine of formpeanate), (chlorthal dimethyl), (chlorophenyls), chloropicrins, chlorpyrifos, chlorpyrifos methyl, clothianidin, codlelure, Cotesia flavipes, coumafos, cryolite, (deltamethrin), (demotonS-methyl), (difenotefuran), (diafonurom), (diazinone), (dicofol) (dimethylvinphos), (dimethoate), (disulfoton), (dithianone), (DNOC), (ecklonia max), (endosulfan), (esfenvalerate), (esfenvalerate+fenitrothion), (espinetoram), (spinosad), (spirodiclofen), (spiromesifene), (spirotetramate), (ethiofencarb), (ethiona), (ethiprole), (ethofenproxy), (etoprofos), (etoxazole), (etridiazole), (methyl eugenol), (methyl eugenol+spinosad), (Sophora flavencens extract), (famfur), (fenamiphos), (fenazaquin), (fenobutho), (phenothrin), (phenoxycarb), (fenpyroximate), (fenpropathrin), (fentoate), (fentiona), (fipronil), (fipronil+alfacipermethrin), (flonicamid), (fluacripirima), (flubendiamide), (flucicloxurone), (flucitrinate), (flufenoxuren), (phosphate), (phosphate), (phosphate), (phosphate of calcium), (magnesium phosphide), (zinc phosphide), (phosphine), (phosmet), (fosthiazate), (phosmet), (gamma-cyhalothrin), gamma-cyhalothrin+malathion, (grandlure), (glandlure+malathion), (hydroxymazole), (hydroxymazole), (hydropenol), (imiphosphos), (imidacloprid), (imidacloprid+flutriafol), (halofenozide), (imidacloprid+thiodocarb), (imidacloprid+triadime), (imiprotrin), (indoxacarb), (isofenphos), (isoprocarb), (isopropyl salicylate), (lambda-cyhalothrin+chlorantraniliprole), (lambda-cyhalothrin+thiamethoxam), (lufenurom), (lufenurom+profenofos), (malationa), (mercarbamo), (metaflumizone), (methamidophos)), (metharhizium anisopliae), (methytidine), (methiocarb), (methomyl), (methomyl+methanol), (methomyl+novalrom), (methoprene), (methoxyfenozide), (metolcarb), (methoxychlor), (mevinphos), (mibemectin), (monocrotophos), (nalede), (nicotine), (oxamyl), (methylene oxide), (fenbutatin oxide), (Paecilomyces lilacinus), (parationa), (paraethyne), (permethrin)), (pymetrozine), (pyraclofos), pyrimidines, pyridaben, pyralidyl, pyrimidiphenyl, pyrimidiphenyl, pyrimidiphenyl, (pyriproxyfen), (prallethrin), (prophenes), (propargite), (propoxides), (propoxides), (prothiophos), (quintals), (resmethrin), (rincofol), (rotenone), (s-cyclopentenyl), (serricornim), (silafluorphene), (sordidim), (steinernema puertoricense), (sulfluramide), (sulfuryl fluoride), (sufotepo), (tebufenozide), (tefubenphedrone), (tebupirinfós), (teflubenzurom), (tefluthrin), (tephosin), (temphos), (terbufos), (diatomaceous earth), (teta cypermethrin), (tetrachlorphosphine), (tetradifon), (tetramethrin), (thiabendazole), (thiacloprid), thiamethoxam+cyanurilazole, thiamethoxam+chlorantraniliprole, thiamethoxam+diphenoconazole+metalaxyl-M), thiocyclam or its hydrochloride salt, thiodicarb, thiophanox, thiometone, sodium thiosulfate, (trichloromethane) (triflumurom), (trimethocarb), (trichloromethane), (trichloromethane), (trichloromethane), (trichloromethane), ((Z)-11-hexadecenal+(Z)-9-hexadecenal), (Z-11-hexadecenal and Z-13-hexadecenal), (Z,Z,Z)-3,6,9-(zeta-cypermethrin), (zeta-cypermethrin+bifenthrin) and the like.

In another embodiment one or more pesticides used in the present method along with biostimulant or biocontrol agent can be selected from:
(a) herbicides selected from a isoxazolidinone herbicide, a urea herbicide, a triazine herbicide, a hydroxybenzonitrile herbicide, a thiocarbamate herbicide, a pyridazine herbicide, chloroacetanilide herbicides; benzothiazole herbicides; carbanilate herbicides, cyclohexene oxime herbicides; picolinic acid herbicides; pyridine herbicides; quinolinecarboxylic acid herbicides; chlorotriazine herbicides, aryloxyphenoxypropionic herbicides, oxadiazolone herbicides; phenylurea herbicides, sulfonanilide herbicides; triazolopyrimidine herbicides, amide herbicides, pyridazine herbicides, dinitroaniline herbicides, or combinations thereof;
(b) fungicides selected from amide fungicides, acylamino acid fungicides, anilide fungicides, benzamide fungicides, sulfonamide fungicides, strobilurin fungicides, aromatic fungicides, benzimidazole fungicides, carbamate fungicides, carbanilate fungicides, conazole fungicides (imidazoles triazoles), copper fungicides, dithiocarbamate fungicides, imidazole fungicides, organophosphorus fungicides, oxazole fungicides, pyrazole fungicides, pyridine fungicides, or combinations thereof;
(c) insecticides selected from arsenical insecticides, botanical insecticides, carbamate insecticides, benzofuranyl methylcarbamate insecticides, dimethylcarbamate insecticides, insecticides, dinitrophenol insecticides, fluorine insecticides, formamidine insecticides, fumigant insecticides, inorganic insecticides, insect growth regulators, benzoylphenylurea chitin synthesis inhibitors, macrocyclic lactone insecticides, neonicotinoid insecticides, nereistoxin analogue insecticides, organochlorine insecticides, organophosphorus insecticides, organothiophosphate insecticides, heterocyclic organothiophosphate insecticides, phenyl organothiophosphate insecticides, phosphonate insecticides, phosphonothioate insecticides, phosphoramidate insecticides, phosphoramidothioate insecticides, phosphorodiamide insecticides, oxadiazine insecticides, oxadiazolone insecticides, phthalimide insecticides, physical insecticides, pyrazole insecticides, pyrethroid insecticides, pyrethroid ether insecticides, pyrimidinamine insecticides, pyrrole insecticides, quaternary ammonium insecticides, sulfoximine insecticides, tetramic acid insecticides, tetronic acid insecticides, thiazole insecticides, thiazolidine insecticides, and thiourea insecticides;
or combinations thereof.

The biostimulants used in the present method can be selected from a group, for example, of seaweed extract, laminarin, superabsorbent polymers (Zeba®), Kasugamin, hexadecenal, ortho-silicic acid, or combinations thereof. In particular embodiments, the plant growth stimulant or biostimulant is selected from the group consisting of ancymidol, butralin, alcohols, chlormequat chloride, cytokinin, daminozide, ethephon, ethylene, humic acid, fulvic acid, flurprimidol, gibberellic acid, gibberellin mixtures, indole-3-butyric acid (IBA), maleic hydrazide, potassium salt, mefluidide, mepiquat chloride, mepiquat pentaborate, naphthalene-acetic acid (NAA), 1-naphthaleneacetamide (NAD), n-decanol, paclobutrazol, prohexadione calcium, trinexapac-ethyl, and uniconazole. Other stimulants which are commercially available include those sold under the trade names BIOZYME® (comprising natural plant extracts, manganese, sulfur, magnesium, boron, iron zinc), PILATUS® (comprising vegetal origin extracts, fulvic acid, inositol, zinc), p-Sodium Nitrophenolate, o-Sodium Nitrophenolate, 5-Sodium Nitroguaiacolate), Tytanit® (comprising magnesium oxide, sulfur trioxide, complexed titanium), Natural occurring plant growth rhizobacteria, BM86®-plant extract, product comprising seaweed based fertilizer, magnesium nitrate, FOLTRON® (comprising nitrogen, phosphorus, potassium, iron, zinc, magnesium, manganese, boron, copper, molybdemum, Folcisteine), or combinations thereof.

Other commercially available biostimulants for example biostimulants based on algal extract, natural extracts for example root stimulant growth stimulant can also be used in the present method for promoting nutrition essential to the plant growth.

Some commercially available biostimulant products for example seaweed extracts and algae extracts for example Ascophyllum nodosum, Fucus vesiculosus, Laminaria digitata, Laminaria hyperborea, Laminaria saccharina, Eklonia maxima, Sargassum spp. and mixtures thereof, can be used in the method of present invention.

The compositions of the present invention can further contain a biopesticide. The term “biopesticide” means pesticides based on micro-organisms (bacteria, fungi, viruses, nematodes, etc.) or natural products (compounds, such as metabolites, proteins, or extracts from biological or other natural sources). Micro-organisms having plant health effects, plant growth regulating effects, nitrogen management effects or micro-organisms improving plant defence, etc. are also understood to be biopesticides in the context of this patent application. Biopesticides are pesticides derived from such natural materials as animals, plants, bacteria, and certain minerals. Biopesticides fall into three major classes. Biochemical pesticides are naturally occurring substances that control pests by non-toxic mechanisms. Microbial pesticides consist of a microorganism (e.g., a bacterium, fungus, virus or protozoan) as the active ingredient.

It is well known fact that nutrients are essential for plant growth, plant metabolism and without them the plant is unable to complete a normal life cycle macro-nutrients are needed in a higher dosage while micro-nutrients may be needed in a lower dosage, e.g., being important as a co-factor for certain enzymes. The exact amount will differ for each crop and also depend on the life stage they are in or the environmental conditions, e.g., water supply, exposure to light, soil properties, and weather.

The present methods comprising the combinations/compositions may further comprise macro-nutrients.

The examples of macronutrients are selected from the group comprising of nitrogen, for example ammonium salts, nitrates, phosphate, for example dihydrogen phosphates, hydrogen phosphates, potassium, e.g., potassium salts, calcium, e.g., calcium salts, iron, e.g., iron salts, sulfur, e.g., sulfates or hydrogen sulfates, or magnesium, e.g., magnesium salts, and the like.

Typically, the methods include the agrochemical composition combined with a supply of nutrients to the plant and can be selected from the group of calcium acetate, calcium ammonium nitrate, calcium borate, calcium carbonate, calcium chelate, calcium chloride, calcium cyanamide, calcium dihydrogen phosphate, calcium fluoride, calcium hydrogen phosphate, calcium hydroxide, calcium nitrate, calcium oxalate, calcium oxide, calcium phosphate, calcium silicate calcium sulfate, dolomitic lime, hydrated lime, quick lime (CaO), tricalcium phosphate, or combinations thereof.

Useful mixing partners include, for example, known agrochemicals. Agrochemicals also referred to as agricultural pesticides, biocides, biologicals or phytosanitary products used in agriculture.

The combinations/composition may optionally include one or more adjuvants. An adjuvant may enhance or improve herbicidal and/or plant growth performance, for example. Adjuvants may be added to the composition at the time of formulation, or by the applicator to a mix prior to treatment. Adjuvants include, for example, surfactants (emulsifier), crop oil, fertilizers, dispersing agents, compatibility agents, foaming activators, foam suppressants, correctives, and spray colorants (dyes). Nonlimiting adjuvants include Crop Oil Concentrate (COC), Methylated Seed Oil, also Soybean Oil, Organo-siliconates, Non-Ionic Surfactants, and Methylated Vegetable Oil Concentrate An adjuvant may be present in any desired amount. For example, 1% to 3% of adjuvant, 3% to 8% of adjuvant, 8% to 16% adjuvant, 17% to 30% adjuvant, or 30% or (e.g., 40% or more) more adjuvant.

The compositions in the present invention mean the compositions of the combinations as described above together with agriculturally suitable auxiliaries, solvents, carriers, surfactants or extenders, in a form as suitable for agrochemical application.

According to the invention, carrier is to be understood as meaning a natural or synthetic, organic or inorganic substance which is mixed or combined with the active compounds for better applicability, in particular for application to plants or plant parts or seeds. The carrier, which may be solid or liquid, is generally inert and should be suitable for use in agriculture.

Suitable solid or liquid carriers are: for example ammonium salts and natural ground minerals, such as kaolins, clays, talc, chalk, quartz, attapulgite, montmorillonite or diatomaceous earth, and ground synthetic minerals, such as finely divided silica, alumina and natural or synthetic silicates, resins, waxes, solid fertilizers, water, alcohols, especially butanol, organic solvents, mineral oils and vegetable oils, and also derivatives thereof. It is also possible to use mixtures of such carriers. Solid carriers suitable for granules are, for example, crushed and fractionated natural minerals, such as calcite, marble, pumice, sepiolite, dolomite, and also synthetic granules of inorganic and organic meals and also granules of organic material, such as sawdust, coconut shells, maize cobs and tobacco stalks.

Suitable liquefied gaseous extenders or carriers are liquids which are gaseous at ambient temperature and under atmospheric pressure, for example aerosol propellants, such as butane, propane, nitrogen, and carbon dioxide.

If the extender used is water, it is also possible for example, to use organic solvents as auxiliary solvents. Suitable liquid solvents are essentially: aromatic compounds, such as xylene, toluene or alkylnaphthalenes, chlorinated aromatic compounds or chlorinated aliphatic hydrocarbons, such as chlorobenzenes, chloroethlenes or methylene chloride, aliphatic hydrocarbons, such as cyclohexane or paraffins, for example mineral oil fractions, mineral and vegetable oils, alcohols, such as butanol or glycol, and also ethers and esters thereof, ketones, such as acetone, methyl ethyl ketone, methyl isobutyl ketone or cyclohexanone, strongly polar solvents, such as dimethylformamide and dimethyl sulphoxide, and also water.

The compositions according to the invention may include additional components, such as, for example, surfactants. Suitable surfactants can be emulsifiers, dispersants or wetting agents having ionic or nonionic properties, or mixtures of these surfactants. Examples of these are salts of polyacrylic acid, salts of lignosul-phonic acid, salts of phenolsulphonic acid or naphthalenesulphonic acid, polycondensates of ethylene oxide with fatty alcohols or with fatty acids or with fatty amines, substituted phenols (preferably alkylphenols or arylphenols), salts of sulphosuccinic esters, taurine derivatives (preferably alkyl taurates), phosphoric esters of polyethoxylated alcohols or phenols, fatty esters of polyols, and derivatives of the compounds containing sulphates, sulphonates and phosphates. The presence of a surfactant is required if one of the active compounds or one of the inert carriers is insoluble in water and when the application takes place in water. The proportion of surfactants is between 0.1 and 50% by weight of the composition according to the invention.

It is possible to use colorants such as inorganic pigments, for example iron oxide, titanium oxide, Prussian blue, and organic dyes, such as alizarin dyes, azo dyes and metal phthalocyanine dyes, and trace nutrients, such as salts of iron, manganese, boron, copper, cobalt, molybdenum and zinc. Thus, in various embodiments, the composition comprises a diluent. In particular embodiments, the diluent is selected from the group consisting of water, an aliphatic hydrocarbon, an aromatic hydrocarbon, or an alkyl ester. The amount of diluent in a composition may range from 1% to 99%, or from 10% to 80%. Suitable diluents include, for example, a non-polar water-immiscible solvent, or a polar aprotic water miscible organic solvent. Non-polar solvents include, for example, substituted or unsubstituted aliphatic or aromatic hydrocarbons and esters of plant oils or mixtures thereof. Non-limiting examples of aromatic hydrocarbons include benzene or substituted benzene derivatives such as toluene, xylene, 1,2,4-trimethylbenzene, naphthalene or mixtures thereof.

Water-miscible polar aprotic solvents include, for example, alkyl lactates, isopropyl lactate, alkyl carbonates, polyethylene glycols, polyethylene glycol alkyl ethers, polypropylene glycols, and polypropylene glycol alkyl ethers, or mixtures thereof.

If appropriate, other additional components may also be present, for example protective colloids, binders, adhesives, thickeners, thixotropic substances, penetrants, stabilizers, sequestering agents, complex formers. In general, the active compounds can be combined with any solid or liquid additive customarily used for formulation purposes.

In general, the compositions according to the invention comprise between 0.01 and 99% by weight, 0.05 and 98% by weight, preferable between 0.1 and 95% by weight, particularly preferred between 0.5 and 90% by weight of the active pesticide compound according to the invention.

Typically, the compositions according to the invention comprise from about 0.05-99% of biostimulant or biological control agent.

The application of present combinations or compositions according to the invention can be on growing plants or all plant parts including seed or seedling to protect the plants or plant parts or harvested crop or crop at storage. The present method thus suitable for providing complete solution required at each stage of the crop.

The combinations or compositions according to the invention can be used as such or, depending on their respective physical or chemical properties, in the form of commercially available products/formulations, such as aerosols, capsule suspensions, cold-fogging concentrates, warm-fogging concentrates, encapsulated granules, fine granules, flowable concentrates for the treatment of seed, ready-to-use solutions, dustable powders, emulsifiable concentrates, oil-in-water emulsions, water-in-oil emulsions, macrogranules, microgranules, oil-dispersible powders, oil-miscible flowable concentrates, oil-miscible liquids, foams, pastes, pesticide-coated seed, suspension concentrates, suspoemulsion concentrates, soluble concentrates, suspensions, wettable powders, soluble powders, dusts and granules, water-soluble granules or tablets, water-soluble powders for the treatment of seed, wettable powders, natural products and synthetic substances impregnated with active compound, and also microencapsulations in polymeric substances and in coating materials for seed, and also ULV cold-fogging and warm-fogging formulations.

When applying the present compositions according to the invention the application rates can be varied within a broad range. The dose of active compound in the combination/application rate usually applied in the method of treatment according to the invention is generally and advantageously for the treatment of part of plants, can be varied or standard recommended dose rate can be used, e.g., leaves (foliar treatment): from 0.01 to 10,000 g/ha, preferably from 50 to 1,000 g/ha, more preferably from 100 to 750 g/ha; in case of drench or drip application, the dose can even be reduced, especially while using inert substrates like rockwool or perlite; for seed treatment: from 2 to 250 g per 100 kg of seed, preferably from 3 to 200 g per 100 kg of seed, more preferably from 2.5 to 50 g per 100 kg of seed, even more preferably from 2.5 to 25 g per 100 kg of seed; for soil treatment: from 0.01 to 10,000 g/ha, preferably from 1 to 5,000 g/ha.

The doses herein indicated are given as illustrative examples of the method according to the invention. A person skilled in the art will know how to adapt the application doses, notably according to the nature of the plant or crop to be treated.

The active compound combination or composition according to the invention can be used in order to protect plants within a certain time range after the treatment against pests or phytopathogenic fungi or microorganisms. The time range, in which protection is effected, spans in general 0 to 60 days preferably 1 to 28 days, more preferably 1 to 14 days, more preferably 1 to 10 days, even more preferably 1 to 7 days after the treatment of the plants with the combinations or up to 200 days after the treatment of plant propagation material. Advantageously, the protection according to the present invention continues till the post-harvest of the crop.

In particular embodiments, present methods employ formulations, for example, a premix or a ready mix or a tank mix or ready to use product.

In one preferred embodiment the method includes application of combination of pesticides and biostimulants, said method involve application of combinations selected from superabsorbent polymer (Zeba), Microbial consortium, Cartap hydrochloride, Carboxin+Thiram, Bispyribac sodium, Oxydiargyl, Acephate+Imidacloprid, carbendazim+Mancozeb, Metalaxyl+Mancozeb, Bifenazate, Oxyfluorfen, flonicamid, Pendimethalin, Glufosinate Ammonium, Haloxyfop R methyl, Emmamectin benzoate, Monochrotophos, Copper sulphate+mancozeb, Azoxystrobin+Mancozeb, Diafenthiuron, Chlorfluazuron, Aluminium phosphide and/or other commercially available crop protection products for the treatment of crops started from seed treatment to post-harvest and storage of the final crop.

In one embodiment the method comprises a complete package for protection of crop, said method comprises application of combination of pesticides and biostimulants, for the protection of cotton crop.

Compositions can be applied in the form of ready to use product. Compositions may also be mixed with other active compounds, such as herbicides, fungicides, insecticides, acaricides, nematicides, bird repellents, growth substances, plant nutrients and agents which improves the soil structure as per the practices known to skilled person.

The compositions according to the invention do not only comprise ready-to-use compositions which can be applied with suitable apparatus to the plant or the seed, but also the commercial concentrates which have to be diluted with water prior to use.

The active compound combinations according to the invention can be present in (commercial) formulations known to a person skilled in the art and in the forms prepared from these formulations as a mixture with other (known) active compounds, such as insecticides, attractants, sterilants, bactericides, acaricides, nematicides, fungicides, growth regulators, herbicides, fertilizers, safeners and adjuvants.

In another aspect the present invention provides a method of stimulating or promoting plant growth comprising applying to a crop plant the present compositions.

In an embodiment the present invention provides a method of stimulating or increasing plant growth comprising applying a pesticide and biostinulant as described above to a plant or a part of a plant or locus thereof in an effective amount to enhance the growth and yield of the plant or plant (s) grown from the plant part.

In an embodiment the pesticide is applied at a rate ranging from about 0.1 g/ha to about 5 kg/ha.

The treatment according to the invention of the plants and plant parts with the active compounds or compositions is carried out directly or by action on their surroundings, habitat or storage space using customary treatment methods, for example by dipping, spraying, atomizing, irrigating, evaporating, dusting, fogging, broadcasting, foaming, painting, spreading-on, watering (drenching), drip irrigating and, in the case of propagation material, in particular in the case of seeds, furthermore as a powder for dry seed treatment, a solution for seed treatment, a water-soluble powder for slurry treatment, by incrusting, by coating with one or more layers, etc. It is furthermore possible to apply the active compound combination by the ultra-low volume method, or to inject the active compound combination or the active compound combination itself into the soil.

The method according to the invention extended in the field of protecting storage goods against attack of insects, nematodes or phytopathogens. According to the present invention, the term “storage goods” is understood to denote natural substances of vegetable or animal origin and their processed forms, which have been taken from the natural life cycle and for which long-term protection is desired. Storage goods of vegetable origin, such as plants or parts thereof, for example stalks, leaves, tubers, seeds, fruits or grains, can be protected in the freshly harvested state or in processed form, such as pre-dried, moistened, comminuted, ground, pressed or roasted. Also falling under the definition of storage goods is timber, whether in the form of crude timber, such as construction timber, electricity pylons and barriers, or in the form of finished articles, such as furniture or objects made from wood. Storage goods of animal origin are hides, leather, furs, hairs and the like. The combinations according the present invention can prevent disadvantageous effects such as decay, discoloration or mold. Preferably “storage goods” is understood to denote natural substances of vegetable origin and their processed forms, more preferably fruits and their processed forms, such as pomes, stone fruits, soft fruits and citrus fruits and their processed forms.

The present invention is compared to an untreated check, or when added to a grower standard program vs. that grower standard program alone. A ‘Grower Standard Program” is the totality of all normal crop protection and fertility applications used to produce a high quality and high-yielding crop.

As demonstrated in the Examples the particular combinations or compositions/formulations and applications rates with specific time period that may be useful are readily determined based on a particular target crop, provide high yield and good quality product.

In some embodiments, stimulating or promoting plant growth is assessed by enhanced seedling germination, plant height, leaf area, biomass, plant vigor, plant color, or combinations thereof. One or more of these characteristics can be measured by conventional means. Others may be assessed by visual observation.

In preferred embodiment the present method provided significant enhancement in seed vigor and good effect on seed germination for soybean crop. Advantageously the crop yield is increased to 10 to 15% than the standard treatments and control treatments.

In some embodiments, enhanced plant height is sufficient increase in height than the control. As demonstrated in the examples herein below, a series of application rates for a particular target crop plant can be used to determine a particular optimal application rate for a given plant, the optimal increase in characteristics being different depending on the exact crop plant.

In some embodiments, the methods include the applying step of the formulations that is carried out post-emergence. In some embodiments, post-emergence comprises the seedling stage of the crop plant. In some embodiments, the methods include the applying step of the formulations that is carried out pre-emergence. In some embodiments, application of the compositions disclosed herein may be performed both pre- and post-emergence. In some embodiments, the applying step involves application of the compositions at any growth stage, including but not limited to, pre-emergence, early post emergence, and later stages of a crop growth cycle.

In one embodiment, the plant to be treated according to the method of the invention is an agricultural plant. “Agricultural plants” are plants of which a part (e.g., seeds) or all is harvested or cultivated on a commercial scale or which serve as an important source of feed, food, fibres (e.g., cotton, linen), combustibles (e.g., wood, bioethanol, biodiesel, biomass) or other chemical compounds.

Preferred agricultural plants are for example cereals, e.g., wheat, rye, barley, triticale, oats, sorghum or rice, beet, e.g., sugar beet or fodder beet; fruits, such as pomes, stone fruits or soft fruits, e.g., apples, pears, plums, peaches, almonds, cherries, strawberries, raspberries, blackberries or gooseberries; leguminous plants, such as lentils, peas, alfalfa or soybeans; oil plants, such as rape, oil-seed rape, canola, linseed, mustard, olives, sunflowers, coconut, cocoa beans, castor oil plants, oil palms, ground nuts or soybeans; cucurbits, such as squashes, cucumber or melons; fiber plants, such as cotton, flax, hemp or jute; citrus fruit, such as oranges, lemons, grapefruits or mandarins; vegetables, such as spinach, lettuce, asparagus, cabbages, carrots, onions, tomatoes, potatoes, cucurbits or paprika; lauraceous plants, such as avocados, cinnamon or camphor; energy and raw material plants, such as corn, soybean, rape, canola, sugar cane or oil palm; tobacco; nuts; coffee; tea; bananas; vines (table grapes and grape juice grape vines); hop; turf; natural rubber plants.

In some embodiments, the combinations described herein may be applied to perennial crops, including, without limitation, stone fruits (cherries, plums, apricots, peaches, nectarines), blueberries, mangos, avocados, pastures, turfgrass, ornamentals, tree crops, eucalyptus, pine, tea, coffee, nut trees, citrus, tropical fruits, pome fruits, grapes and vines, perennial grasses, cranberries, bananas, sugarcane. In some embodiments, the crop is selected from the group consisting of corn, wheat, soybean, dry bean, cotton, cereals, rice, maize, sorghum, sugar cane, canola, soya, turf, barley, potato, sweet potato, sunflower, rye, oats, sugar beet, safflower, alfalfa, cassava, cucurbits, pineapple, and pastures.

Examples for vegetables are potatoes, tomatoes, peppers, cucurbits, cucumbers, melons, watermelons, garlic, onions, carrots, cabbage, beans, peas and lettuce and more preferably from tomatoes, onions, peas, and lettuce. Examples for fruits are apples, pears, cherries, strawberry, citrus, peaches, apricots, and blueberries. In one embodiment, the plant to be treated according to the method of the invention is an ornamental plant. “Ornamental plants” are plants which are commonly used in gardening, e.g., in parks, gardens and on balconies. Examples are turf, geranium, pelargonia, petunia, begonia and fuchsia.

In an embodiment, the present invention provides increased yield of tubers per plant, higher productivity of potatoes and better sanity and vigor.

In an embodiment the present invention provides a method for protection and growth of cotton crop.

In an embodiment the present invention provides a method for protection and growth of tomato crop.

In an embodiment the present invention provides a method for protection and growth of corn and soybean crop.

In an embodiment the present invention provides a method for protection and growth of wheat and rice crop.

In an embodiment, the method comprises simultaneous, separate or sequential application of desired product combinations to a plant or plant propagation material or locus thereof.

Surprisingly, the methods according to the invention improves the growth of the plants, increase the yield, and improve the tolerance of the plants to abiotic stress.

In accordance with the present invention, there is an improvement in plant vigour, enhancement in product quality and increase in size of the final product.

The term “increasing the yield” of a plant means that the yield of a product of the plant is increased by a measurable amount over the yield of the same product of the plant produced under the same conditions, but without the application of the combinations according to the present invention. It is preferred that the yield is increased by at least about 0.5%, preferably 1%, more preferably 2%, yet more preferably 4% or more. Even more preferred is an increase in yield of at least about 5%, 10%, 15% or 20% or 30% or more. In addition to this the overall cost for protection and growth of crop according to the present method is reduced to at least 25% to 30% as compared to the conventional method which provides a great economic advantage to the farmer in agriculture.

In accordance with the present invention, “crop enhancement” means an improvement in plant vigour, an improvement in plant quality and/or improved tolerance to stress factors.

In accordance with the present invention, an “improvement in plant vigour” means that certain traits are improved qualitatively or quantitatively when compared with the same trait in a control plant which has been grown under the same conditions in the absence of the method of the invention. Such traits include, but are not limited to, early and/or improved germination, improved emergence, the ability to use less seeds, increased root growth, a more developed root system, in-creased root nodulation, increased shoot growth, increased tillering, stronger tillers, more productive tillers, increased or improved plant stand, less plant verse (lodging), an increase and/or improvement in plant height, an increase in plant weight (fresh or dry), bigger leaf blades, greener leaf colour, increased pigment content, increased photosynthetic activity, earlier flowering, longer panicles, early grain maturity, increased seed, fruit or pod size, increased pod or ear number, increased seed number per pod or ear, increased seed mass, enhanced seed filling, less dead basal leaves, delay of senescence, improved vitality of the plant, increased levels of amino acids in storage tissues and/or less inputs needed (e.g., less fertiliser, water and/or labour needed). A plant with improved vigour may have an increase in any of the aforementioned traits or any combination or two or more of the aforementioned traits.

In accordance with the present invention, an “improvement in plant quality” means that certain traits are improved qualitatively or quantitatively when compared with the same trait in a control plant which has been grown under the same conditions in the absence of the method of the invention. Such traits include, but are not limited to, improved visual appearance of the plant, reduced ethylene (reduced production and/or inhibition of reception), improved quality of harvested material, e.g. seeds, fruits, leaves, vegetables (such improved quality may manifest as improved visual appearance of the harvested material), improved carbohydrate content (e.g., increased quantities of sugar and/or starch, improved sugar acid ratio, reduction of reducing sugars, increased rate of development of sugar), improved protein content, improved oil content and composition, improved nutritional value, reduction in anti-nutritional compounds, improved organoleptic properties (e.g., improved taste) and/or improved consumer health benefits (e.g., increased levels of vitamins and anti-oxidants), improved post-harvest characteristics (e.g., enhanced shelf-life and/or storage stability, easier processability, easier extraction of compounds), more homogenous crop development (e.g., synchronised germination, flowering and/or fruiting of plants), and/or improved seed quality (e.g., for use in following seasons). A plant with improved quality may have an increase in any of the aforementioned traits, or any combination or two or more of the aforementioned traits.

In accordance with the present invention, an “improved tolerance to stress factors” means that certain traits are improved qualitatively or quantitatively when compared with the same trait in a control plant which has been grown under the same conditions in the absence of the method of the invention. Such traits include, but are not limited to, an increased tolerance and/or resistance to abiotic stress factors which cause sub-optimal growing conditions such as drought (e.g., any stress which leads to a lack of water content in plants, a lack of water uptake potential or a reduction in the water supply to plants), cold exposure, heat exposure, osmotic stress, UV stress, flooding, increased salinity (e.g. in the soil), increased mineral exposure, ozone exposure, high light exposure and/or limited availability of nutrients (e.g. nitrogen and/or phosphorus nutrients). A plant with improved tolerance to stress factors may have an increase in any of the aforementioned traits or any combination or two or more of the aforementioned traits. In the case of drought and nutrient stress, such improved tolerances may be due to, for example, more efficient uptake, use or retention of water and nutrients.

The combinations/compositions of present invention may be applied to the locus of the plant on one or more occasions/key stages during the growth of the plant till post-harvest of the crop. It can be applied to the planting site before the seed is sown, during the sowing of the seed, pre-emergence and/or post-emergence stage and final storage of harvested crop. The combinations can also be used while the plant is being grown in a green house and the use can be continued after transplantation. The soil may, for example, be treated directly, prior to transplanting, at transplanting or after transplanting. The combinations/compositions can be applied via any suitable method, which ensures that the agents penetrate the soil, for example, nursery tray application, in furrow application, soil drenching, soil injection, drip irrigation, application through sprinklers or central pivot, incorporation into soil (broad cast or in band) are such methods.

The rate and frequency of use of the combinations/compositions on the plant may vary within wide limits and depends on the type of use, the specific active agents, the nature of the soil, the method of application (pre- or post-emergence, etc.), the plant to be controlled, the prevailing climatic conditions, and other factors governed by the method of application, the time of application, and the target plant.

When employed in plant protection, the amounts of active substances applied are, depending on the kind of effect desired, standard methods known to skilled person, preferably from 0.001 to 10 kg per ha, preferably from 0.001 to 5 kg per ha or 0.001 to 2 kg per ha preferably from 0.005 to 1 kg per ha, in particular from 0.005 to 0.5 kg per ha.

In another aspect the present invention provides a kit of parts comprising a kit for complete pesticide solution:
combination a pack containing
a) at least one biostimulant and
b) at least one pesticide compound selected from groups i) to iii):
   i) a herbicide
   ii) an insecticide
   iii) a fungicide
or combinations thereof.

In an embodiment the kit containing said pack comprises ready formulations of at least one biostimulant and at least one pesticide selected from the groups i) to iii) and a user manual for the user to apply the products on the crop to achieve high crop yield and healthy food quality.

Embodiments herein are generally disclosed herein using affirmative language to describe the numerous embodiments. The disclosure also specifically includes embodiments in which particular subject matter is excluded, in full or in part, such as substances or materials, method steps and conditions, protocols, procedures, assays or analysis. Thus, even though the embodiments are generally not expressed herein in terms of what the invention does not include aspects that are not expressly included are nevertheless disclosed herein.

The good herbicidal or fungicidal or insecticidal or nematicidal activity of the active compound in combinations/compositions as well as usefulness of unique method with integrated programme to provide plant protection at all stages of the crop as described above according to the present invention is evident from the example below.

### EXAMPLES

### Example 1

A cotton crop protection and nutrition programme with a one stop solution to provide nutrition with certain active ingredients that have an impact on the crop at different life stages was performed. This method was found to be effective and better than the conventional crop protection products.

TABLE 1

| Cotton Crop Management Package | | | | | | |
|---|---|---|---|---|---|---|
| Segment | Soil health | | Crop protection | | | |
| Application | May Last Week | | May Last Week | July-August- | June-July | July |
| Time | | | and June Early | Sept | | |
| Stage of Crop | While Sowing | Land | Pre-emergence | | | Square |
| | | Preparation | | | | Development |
| | | or Top | | | | to Early |
| | | Dressing of | | | | Flowering |
| | | fertilizers | | | | |
| | | | (Just after | | | (60-75 DAS) |
| | | | sowing within | | | |
| | | | 48 Hr) & 30 | | | |
| | | | DAS | | | |
| Crop Package | UPDT (Zeba ®) | Microbial | Pendimethalin | Glufosinate | Flonicamid | Flonicamid 80 |
| (Dose to be | 5 Kg/acre | consortium | 700 ML | Ammonium/ | 80 G + | G + |
| given per | | 3 Kg/acre | | Haloxyfop R | Ortho | Emmamectin |
| Acre) | | | | methyl | silicic acid | benzoate 100 |
| | | | | | (OSA) 500 | G + OSA 500 |
| | | | | | ML | ML + |
| | | | | | | Carbendazim + |
| | | | | | | Mancozeb 500 |
| | | | | | | G |
| Pest control & | Absorb water | | Pre-emergence | Post | Jassids, | White Fly, |
| Disease | and fertiliser | | Weed | Emergence & | Aphids, | Thrips, |
| Management | (Below Ground | | Management | Grassy Weeds | White Fly, | Jassids, Leaf |
| | in Root Zone) | | | | Good Plant | Spot, Plant |
| | and release at | | | | Stand | Health |
| | the time of plant | | | | | |
| | needs | | | | | |

| Cotton Crop Management Package | | | | |
|---|---|---|---|---|
| Segment | Crop protection | | | |
| Application | July-August | August- | September- | October |
| Time | | September | October | |
| Stage of Crop | Flowering Stage | Peak Flowering | Boll Maturity | Maturity |
| | | to Boll | to Harvesting | |
| | | Formation | Stage (90-105 | |
| | | | DAS) | |
| | (75-90 DAS) | (90-105 DAS) | | (120 |
| | | | | DAS) |
| Crop Package | Acephate + | Flonicamid 80 | Diafenthiuron | |
| (Dose to be | Imidacloprid + | G or | 500 G | |
| given per | Monochrotophos + | Diafenthiuron + | (optional) + | |
| Acre) | Azoxystrobin + | Copper | Chlorfluazuron | |
| | Mancozeb 600 G | sulphate + | 800 ML | |
| | | mancozeb 500 | | |
| | | G + OSA 500 | | |
| | | ml | | |
| Pest control & | White Fly, Thrips, | White Fly, | White Fly | |
| Disease | Jassids, Leaf Spot, | Grey Mildew, | Spodoptera | |
| Management | Prevent Flowr | Pink Bollworm | litura | |
| | Drop, Plant | | | |
| | Health | | | |

The cotton crop package and the method of applying product at key stages provided in above table enhanced the yield of the crop, preferably it resulted in a 15% to 20% increase in yield with improved the quality of the crop.

### Example 2

This trial was designed to evaluate the effects of biostimulants when combined with one or more pesticides (Pronutiva®) establishing long term sustainable programs for almond growers that may have reduced environmental impact, as well as reduced crop pesticide residues. It is evident from the table below that Treatment 6 (T6) resulted in an overall larger nut size which would provide an increase of a $0.10/1b premium vs. Treatments 1-5. The treatment according to the present invention provided higher yield and cost benefit as compared to regular conventional treatment practices.

TABLE 2

| | | | | | Yield |
|---|---|---|---|---|---|
| | Nut Size (Almond) | | | | Lbs. Nut |
| Treatment | Bisabri 1 | Bisabri 2 | Sawtooth | Ave All | Meat/Acre |
| T1 | 25.1 | 31.1 | 28.4 | 28.2 | 1994 |
| T2 | 23.2 | 30.6 | 28.6 | 27.5 | 1973 |
| T3 | 25.1 | 29.9 | 29.5 | 28.1 | 1989 |
| T4 | 25.5 | 30 | 28.9 | 28.1 | 2061 |
| T5 | 24.9 | 29.7 | 28.9 | 27.8 | 2155 |
| T6 | 23 | 28.7 | 28.7 | 26.8 | 2172 |

TABLE 3
Standard Program

| Treatment (T0) Control | T1 | T2 |
|---|---|---|
| Propiconazole @ 8 oz/A | Propiconazole @ 8 oz/A | Propiconazole @ 8 oz/A |
| @ Early Bloom | @ Early Bloom | @ Early Bloom |
| fluxapyroxad + pyraclostrobin | fluxapyroxad + pyraclostrobin | fluxapyroxad + pyraclostrobin |
| @ 5.5 oz/A @ Bloom | @ 5.5 oz/A @ Bloom | @ 5.5 oz/A @ Bloom |
| chlorothalonil @ 24.0 oz/A | chlorothalonil @ 24.0 oz/A | chlorothalonil @ 24.0 oz/A |
| @ Post Petal Fall | @ Post Petal Fall | @ Post Petal Fall |
| fluopyram/trifloxystrobin | fluopyram/trifloxystrobin | Polyoxin D Zinc salt @ 6.2 oz/A |
| @ 6.0 oz/A @ Nut Sizing | @ 6.0 oz/A @ Nut Sizing | @ Nut Sizing |
| abamectin SC @ 4.5 oz/A | Bifenazate @ 16.0 oz/A | Bifenazate @ 16.0 oz/A |
| @ Nut Sizing | @ Nut Sizing | @ Nut Sizing |
| Chlorantraniliprole @ 4.5 oz/A | Chlorantraniliprole @ 4.5 oz/A | Chlorantraniliprole @ 4.5 oz/A |
| @ Hull Split | @ Hull Split | @ Hull Split |

New Program

| T3 | T4 | T5 |
|---|---|---|
| Propiconazole @ 8 oz/A | Propiconazole @ 8 oz/A | Propiconazole @ 8 oz/A |
| @ Early Bloom | @ Early Bloom | @ Early Bloom |
| BM 86 @ 64 oz/A | fluxapyroxad + pyraclostrobin | BM 86 @ 64 oz/A |
| @ Early Bloom | @ 5.5 oz/A @ Bloom | @ Early Bloom |
| fluxapyroxad+ pyraclostrobin | chlorothalonil @ 24.0 oz/A | fluxapyroxad + pyraclostrobin |
| @ 5.5 oz/A @ Bloom | @ Post Petal Fall | @ 5.5 oz/A @ Bloom |
| Nutritional formulation-BM 86 | Pilatus @ 32 oz/A (Thru Drip) | chlorothalonil @ 24.0 oz/A |
| @ 64 oz/A @ Bloom | @ Petal Fall | @ Post Petal Fall |
| chlorothalonil @ 24.0 oz/A | Polyoxin D Zinc salt @ | Nutritional formulation-BM 86 |
| @ Post Petal Fall | 6.2 oz/A @ Nut Sizing | @ 64 oz/A @ Bloom |
| Polyoxin D zinc salt - @ | Bifenazate @ 16.0 oz/A | Pilatus @ 32 oz/A (Thru Drip) |
| 6.2 oz/A @ Nut Sizing | @ Nut Sizing | @ Petal Fall |
| Bifenazate- @ 16.0 oz/A | Composition of Plant extract, | Polyoxin D Zinc salt @ |
| @ Nut Sizing | fulvic acid, amino acids, | 6.2 oz/A @ Nut Sizing |
| | Inositol -Pilatus @ 32 oz/A | |
| | (Thru Drip) @ 30 Days Post | |
| | Petal Fall | |
| Chlorantraniliprole - @ | Chlorantraniliprole @ | Bifenazate @ 16.0 oz/A |
| 4.5 oz/A @ Hull Split | 4.5 oz/A @ Hull Split | @ Nut Sizing |
| — | — | Composition of Plant extract, |
| | | fulvic acid, amino acids, |
| | | Inositol Pilatus @ 32 oz/A |
| | | (Thru Drip) @ 30 Days Post |
| | | Petal Fall |
| — | — | Chlorantraniliprole @ |
| | | 4.5 oz/A @ Hull Split |

The new program of the present invention includes the application of the combination of an herbicide, insecticide, fungicide and biostimulant. The results show that this new program is very effective to promote plant growth and increase the yield of the crop.

### Example 3

This test was performed with 4 repetitions and 4 treatments in corn crop. In the first (treatment 1), the plant was treated only with an herbicide as a comparison reference. The other treatments (2, 3 and 4) used a blend of a folcysteine-based biostimulant and an herbicide, for example, ammonium glufosinate, at a volume of 300 l/ha was sprayed on stage V4 corn plants.

TABLE 4

| | Dose | Weight of 1,000 grains | | Productivity | |
|---|---|---|---|---|---|
| Treatments | (kg-l/ha) | (g) | Index | (kg/ha) | Index |
| 1. Y | 1.50 | 25.89 a | 100 | 7.142 b | 100 |
| 2. B1 | 0.50 | 27.95 a | 108 | 8.358 a | 117 |
| 3. B1 | 1.00 | 27.75 a | 107 | 8.375 a | 117 |
| 4. B1 | 2.00 | 30.26 a | 117 | 8.498 a | 119 |

Key:
Y = ammonium glufosinate herbicide
B1 = blend of a folcysteine-based biostimulant and an ammonium glufosinate-based herbicide.

The results of the application according to the present invention showed that it consistently increased the weight of harvested corn grains and the yield measured in volume of grain per hectare (treatment 2). This performance was repeated in subsequent treatments (see treatments 3 and 4), and consistent results were observed.

### Example 4

This test was performed with 4 repetitions and 4 treatments. Treatment 1 is a sample of the plant with no treatment at all (control), and the other treatments (2, 3 and 4) used a blend of a folcysteine-based biostimulant and an herbicide (fomesafen+fluazifop-p-ethyl), sprayed in a volume of 200 l/ha of the blend applied to bean plants. The results can be seen in the following chart:

TABLE 6

Productivity

| Treatment | Dose (kg-l/ha) | (kg/ha) | Index |
|---|---|---|---|
| 1. Control | — | 3.582 | 100 |
| 2. B2 | 0.5 | 3.804 | 106 |
| 3. B2 | 1.0 | 4.206 | 117 |
| 4. B2 | 2.0 | 4.326 | 121 |
| 5. B3 | 0.5 | 4.308 | 120 |
| 6. B3 | 1.0 | 4.242 | 118 |
| 7. B3 | 2.0 | 4.440 | 124 |
| 8. B2/B3 | 0.5/0.5 | 4.290 | 120 |
| 9. B2/B3 | 1.0/1.0 | 5.280 | 147 |
| 10. B2/B3 | 2.0/2.0 | 5.370 | 150 |

Control = plant with no treatment.
B2 = Blend of a folcysteine-based biostimulant and an agrotoxic of interest, a fomesafen + fluazifop-p-ethyl based herbicide.
B3 = blend of a folcysteine-based biostimulant and a pyraclostrobin based fungicide

The results showed that when a folcysteine-based biostimulant was applied with a fomesafen+fluazifop-p-ethyl based herbicide, specifically in stage V4, followed by a second application of the blend together with a pyraclostrobin-based fungicide, this three-application treatment increased yields by 20% to 50%.

### Example 5

Laboratory tests were performed to measure mite control using the combinations of present invention, specifically in the control of Tetranychus urticae with 4 repetitions and 4 treatments.

TABLE 7

| | Dose | | | | | |
|---|---|---|---|---|---|---|
| | (g-mL/ | Mite control (%) | | | | |
| Treatment | 100 L) | 1 DFA | 2 DFA | 3 DFA | 4 DFA | 7 DFA |
| 1. Control | — | 0 | 0 | 0 | 0 | 0 |
| 2. X | 200 | 0 | 0 | 0 | 3 | 11 |
| 3. Y | 30 | 20 | 20 | 20 | 45 | 62 |
| 4. X + Y | 200 + 30 | 63 | 69 | 90 | 95 | 100 |

Key:
DFA = Days following application
Control = plant with no treatment.
X = folcysteine-based biostimulant
Y = agrotoxic of interest, abamectin-based miticide.

The results in above table showed that the application of a folcysteine-based biostimulant and an insecticide led to significant increase in effectiveness in eliminating Tetranychus urticae mites, especially in the first- and second-day following application (DFA), following after the third, fourth and seventh days.

### Example 6

This trial was performed in the field for evaluating the impact of a combined treatment that is herbicide (Clethodim+Quizalofop) with biostimulant comprising fulvic acid (K-tionic®) according to present invention for the control of grass, Brachiaria decumbens (BRADC).

TABLE 8

| | | Dose of active | | BRADC |
|---|---|---|---|---|
| No. | Treatments/a.i. | ingredient | Application | 38 DAA |
| 1 | Untreated | — | initial post - | 0 |
| | | | 2 to 4 tillers | |
| 2 | Clethodim + | 72 | initial post - | 42 |
| | Quizalofop | | 2 to 4 tillers | |
| 3 | Clethodim + | 144 | initial post - | 60 |
| | Quizalofop | | 2 to 4 tillers | |
| 4 | Clethodim + | 144/125/0.5 | initial post - | 76 |
| | Quizalofop/Fulvic | | 2 to 4 tillers | |
| | acid | | | |
| 5 | Clethodim + | 144/250/1.0 | initial post - | 77 |
| | Quizalofop/Fulvic | | 2 to 4 tillers | |
| | acid | | | |
| 6 | Clethodim + | 72/130.13 | initial post - | 57 |
| | Quizalofop/ | | 2 to 4 tillers | |
| | Organic-mineral | | | |
| 7 | Clethodim + | 108/130.13/1.0 | initial post - | 75 |
| | Quizalofop/ | | 2 to 4 tillers | |
| | Organic-mineral | | | |
| 8 | Clethodim + | 125/72/130.13 | initial post - | 60 |
| | Quizalofop/Fulvic | | 2 to 4 tillers | |
| | acid/Organic- | | | |
| | mineral | | | |

The results showed enhancement in the control of weeds in the field.

### Example 7

The field trials were carried out for evaluating the effect of a combination of insecticide plus biostimulant (ortho silicic acid) against corn fall armyworm (FAW) (Spodoptera frugiperda).

Application method: Two applications (application A and B) within an interval of 14 days. A01=1 day after first spray, B07=7 days after 2nd spray.

TABLE 9

| | | | Target: Corn FAW | | | |
|---|---|---|---|---|---|---|
| | | | (Spodoptera frugiperda) | | | |
| | | Dose | Post 1^{st} & 2^{nd} application | | | |
| | | Active | Percent Control (%) | | | |
| Sr. No. | Treatments | (gm a.i./ha) | A01 | B07 | B10 | B21 |
| T-1 | Untreated | | [1.4] | [3.3] | [3.6] | [4.6] |
| | Check | | | | | |
| T-2 | OSA + CTPR | 25 + 30 | 71.7 | 93.7 | 95.3 | 93.4 |
| T-3 | OSA + | 25 + 75 | 69.5 | 91.7 | 91.5 | 88.5 |
| | Novaluron | | | | | |
| T-4 | OSA + | 25 + 90 | 72.2 | 93.8 | 94.5 | 91.3 |
| | Novaluron + | | | | | |
| | Lambda | | | | | |
| | cyhaothrin | | | | | |
| T-5 | OSA + | 25 + 125 | 76.8 | 96.9 | 96.4 | 94.2 |
| | Novaluron + | | | | | |
| | Ememectin | | | | | |
| T-6 | OSA | 25 | 32.4 | 58.6 | 60.6 | 59 |
| T-7 | CTPR | 30 | 67.6 | 86.8 | 88.9 | 87 |
| T-8 | Novaluron | 75 | 60.5 | 88.8 | 88.9 | 84.7 |
| T-9 | Novaluron + | 90 | 67.6 | 89.5 | 90.7 | 89 |
| | Lambda | | | | | |
| | cyhalothrin | | | | | |
| | ′LSP P = .05 | | 14.4 | 5.25 | 6.27 | 5.16 |

OSA: Orthosilicic acid,
CTPR: Chlorantraniliprole

Thus, it is concluded from the above results that the method of present invention is efficient and effectively control the corn fall armyworm.

### Example 8

This trial was performed to evaluate the maize crop protection and nutrition program with a one stop solution for the growers and sustainable agriculture. The present method with application of certain active ingredients provided surprising benefits at different life stages of the crop and promoted the plant growth.

TABLE 10

| Segment | Crop Establishment & | | Crop Protection for Maize | | | | | Harvesting |
|---|---|---|---|---|---|---|---|---|
| | Soil Health Segment | | | | | | | Stage |
| Customer | June (2^{nd} week) | | June (2^{nd} Week) | July (1^{st}-3^{rd} | July- | August | September | September |
| engagement | | | | Week) | August (3^{rd} | (1^{st}-4^{th} | (1^{st}-3^{rd} Week) | (Last |
| activity | | | | | Week-1^{st} | Week) | | Week) |
| | | | | | Week) | | | |
| Stage of | Before | Land | Pre-emergence | Early Post | Vegetative | Flowering | Pod | Harvesting |
| Crop | Sowing | Preparation or | (Just after sowing | Emergent | Stage | Stage | Stage (55- | Stage |
| | (Seed | along with | within 48 Hr) | Weeds | (25-40 | (40-55 | 70 DAS) | |
| | Treatment) | Sowing | | (7-10 DAS, | DAS) | DAS) | | |
| | | | | Weeds at 2-4 | | | | |
| | | | | Leaf Stage) | | | | |
| Crop | Start Up | Zeba (starch- | Metalochlor 800 | Atrazine - | Sorter - 500 | Avancer | Cypermethrin + | Aluminum |
| Package | (Carbendazim + | based, | ml + Neozin - | 500 gm | gm + ortho | Glow - | Quinalphos - | phosphide |
| (Dose to be | Manoczeb)- | superabsorbent) - | 500 gm | | silicic acid | 600 gm +, | 400 ml | 10 gm |
| given per | 2.5 gm per KG | 5 KG + | | | 250 ml | Gunther - | | Pouch/12 |
| Acre) | Seed + | Copio - 3 | | | | 400 ml + | | gm Tablet - |
| | Thimexotham | | | | | ortho | | 4 Tablet per |
| | 5 ml per KG | | | | | silicic | | MT of |
| | | | | | | acid - 250 | | |
| | | | | | | ml | | |
| Pest & | Soil born Pest (White Grub, | | Pre-emergence | Post | Fall Army | Fall Army | Fall Army | Stored |
| Disease | Termites) | | Weed | Emergent | Worm, Stem | Worm | Worm | Grain Pests |
| Management | Diseases (Roots Rots) | | Management | Broad Leaf | Borer and | and Rust | | |
| | Management | | | and Narrow | other | | | |
| | | | | Leaf Weeds | Lepidopteran | | | |
| | | | | Management | Pest | | | |
| Advantages | — | — | 1) Coverage of | — | Best solution | Cures all | Useful in | Quality |
| and Benefits | | | many hard to kill | | in this | fungal | Cross | Packing |
| | | | weeds | | segment to | diseases | Resistance | Quality |
| | | | 2) Longer Control | | restrict the | and very | Management | Secondary |
| | | | on weeds | | FAW in | safe at | Faster Control | Packing is |
| | | | | | initial stage. | flowering | | safe for |
| | | | | | Increase | This is | | Competitive |
| | | | | | Crop | giving | | Price |
| | | | | | Resistance | Fast, | | |
| | | | | | Power | Longer | | |
| | | | | | against FAW | and best | | |
| | | | | | Infestation, | control | | |
| | | | | | Increases | | | |
| | | | | | efficacy and | | | |
| | | | | | efficiency of | | | |
| | | | | | Insecticide | | | |

This programme offers excellent protection for maize from harmful insects and provide high yield and good quality crop.

### Example 9

This trial was performed to evaluate the present method and assess Crop Health and Yield Benefits.

METHOD
Efficacy and Plant health Assessments - Rating @ 5, Scale, 10, Pl 15, 30, stress, 45, Less 60 DAS
Crop Corn
Target Plant health/Weeds/Insects pests/Diseases/Yield
Plot size 2000 m2

| Crop stage | Crop package | Target pest/disease |
|---|---|---|
| Before Sowing - Seed treatment | A- 2.5 ml/KG Seed + | Soil born Pest (White Grub, |
| | B- 10 ml/kg Seed | Termites) Diseases (Root Rots) |
| | | Management |
| Land Preparation or along with Sowing | C - 5 KG + D - 3 KG | Soil health water stress and Nutrition |
| | | Uptake |
| Pre-emergence (0-3 DAS) (Just after | E-1000 ml + F-500gm | Pre-emergence Weed Management |
| sowing within 48 Hr) | | |
| Need Based Early Post Emergent weeds | F - 500 gm | Post Emergent Broad Leaf and |
| (7-10 DAS, weed at 2-4 leaf stage) | | Narrow Leaf Weeds Management |
| Vegetative Stage (10-15DAS) | G- 500 gm + H- 250 ml | Fall Army Worm, Stem Borer and |
| | | Other Lepidopteran Pest |
| Flowering Stage (40-55 DAS) | I - 600 gm + J 400 ml + | Fall Army Worm and Rust |
| | H- 250 ml | |
| Cob stage (55-70 DAS) | K- 400 ml | Fall Army Worm |

A-Carboxin+Thiram, B-Thiamethoxam, C-Super absorbent polymer (Zeba®),), D-Microbial consortium (Copio), E-Metolachlor, F-Atrazine, G-Acephate+Cypermethrin, H-Ortho silicic acid, I-Azoxystrobin+Mancozeb, J-Novaluron+Emamectin benzoate, K-Cypermethrin+Quinalphos

RESULTS

| | 15 DAS | | 40 DAS | | | 62 DAS | | |
|---|---|---|---|---|---|---|---|---|
| | Avg. Plant | Plant Vigour | | Stem | Plant | Avg. | Stem | Plant |
| | height (cm) | (Visual) | Avg. Plant | Diameter | Vigour | Plant | Diameter | Vigour |
| Present crop | 29.81 | 9 | 84.58 | 24.0 | 9 | 169 | 34.48 | 9 |
| protection method | | | | | | | | |
| Farmers Practice | 23.60 | 6 | 62.62 | 18.9 | 6 | 131 | 26.66 | 6 |
| | 6.21 | | 21.96 | 5.1 | | 38 | 7.82 | |

It can be seen from above table that present method provides better results and also it is beneficial to farmers/growers in cost-benefit ratio. Further it provides a superb phytotonic effect on crops and an additional 50% yield was observed. This means the total yield observed from present method was higher than the farmer's standard practice.

| | Avg. of 10 plants | | | | | Yield | |
|---|---|---|---|---|---|---|---|
| Cultivation | Cob length | Cob girth | No of | No of | Test wt (100 | Kg/2000 | |
| Package | (cm) | (mm) | rows/cob | grains/cob | grains (g)) | sq · m | q/ac |
| Present | 17.79 | 47.22 | 14 | 549 | 35.11 | 960.0 | 19.20 |
| invention | | | | | | | |
| Farmer | 15.20 | 42.81 | 14 | 447 | 29.43 | 639.0 | 12.78 |
| Practice | | | | | | | |
| Differentiator | 2.59 | 4.41 | — | 102 | 5.68 | 321 | 6.42 |

### Example 10

This trial was performed to evaluate the present crop protection and development method and assess the Crop Health and Yield Benefits:

METHOD

| | Evaluation of ProNutiva Concept |
|---|---|
| | to assess Crop Health & |
| Objective | Yield Benefits |
| Crop | Wheat |
| Target Weeds | Plant/Weeds/Insects pests/Diseases |
| Trial Design | Design (LPT) Large plot trial |
| Method Water volume | 500 L/ha or as per the practice |
| Plot size (m2) | 2500 sq. m |

| Crop Stage | Crop Package |
|---|---|
| Seed treatment | 250 ml A + 250 ml B |
| Land Preparation & Transplanting | C- 5 kg/acre, D- 3 kg/acre |
| 0-3 Days after sowing (Pre-emergence) | E- @ 1500 ml/acre |
| Crown root stage (21-30 DAS) | F- 500 g/acre |
| Tillering stage (25/35 DAS) | G- @ 200 g/gram and H- @ |
| | 16 g/acre for UP |
| Booting stage (60/65 DAS) | B + I + J |
| Milk stage (90-105 DAS) | K- (Need based) |
| Dough stage (110-120 DAS) | L (For Pink stem borer) |
| Need Based | M (For yellow rust) |

Assessments
% germination, Seedling Vigour Index, PI height, No of tillers
Observation on Plant height, Plant Vigour (Poor, Good, Very
good, Excellent), Plant vigour Index
Efficacy - % Weed control
% Disease, Insect control, PI health
Yield & yield attributing assessments

A-Carboxin+Thiram, B-Thiamethoxam, C-Super absorbent polymer (Zeba®)), D-Microbial consortium (Copio), E-Pendimethalin, F-Carbendazim+Mancozeb, G-Metribuzin (Shagun), H-Thiamethoxam, I-Azoxystrobin+Mancozeb, J-Ortho silicic acid, K-Zinc Phosphide, L-Cypermethrin+Quinalphos, M-Propiconazole.

### Results

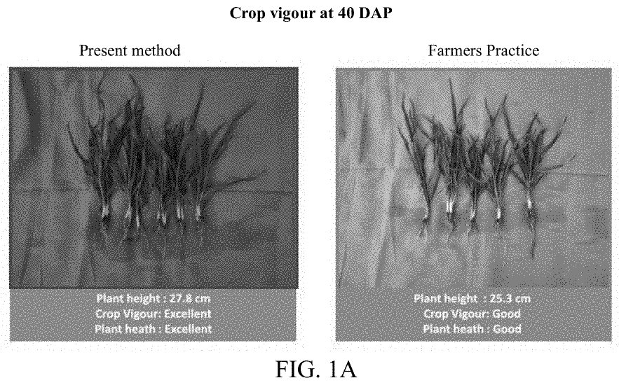

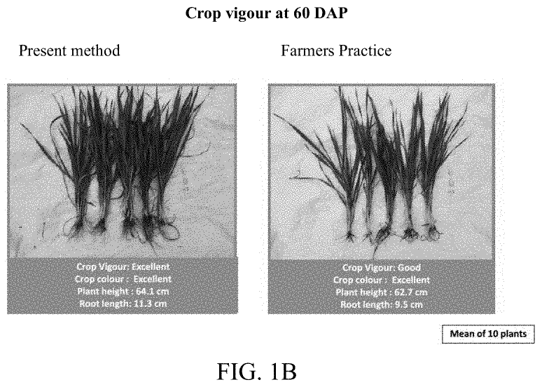

It was observed that crop vigour with present was excellent and enhanced the plant health as represented in FIGS. 1a and 1b. Further advantages include, weed free field, root developments, healthy plants, more effective tillers, sucking pests control, disease free, insect free, healthy spike, disease free spike, and quality of grain was excellent.

YIELD ASSESSMENT

| Particulars | Pronutiva concept | Farmer practices |
|---|---|---|
| Yield (Qt/Acre) | 23.20 | 19.60 |
| % yield increases over | 15.50% | |
| Farmer Practices | | |
| Yield Increases | 3.6 Qt | |
| Grain Quality - Bold seeds | Excellent | Good |

From the above table it is clear that present invention provides an additional 15% yield. Further, the cost of cultivation per acre was also reduced when the present crop management program was applied in the field.

1. A method comprising applying to a locus an effective amount of
a) at least one component selected from a herbicide an insecticide; a fungicide or combinations thereof, and
b) a biostimulant

2. The method as claimed in claim 1, wherein said method comprises applying concurrently or subsequently or sequentially at least one or more components selected from a) along with component of b) to the locus.

3. The method as claimed in claim 1, further comprising applying a biological control agent to the locus.

4. The method as claimed in claim 1, wherein said method comprises first application of the biostimulant and second application of the at least one component selected from the herbicide, fungicide, or insecticide.

5. The method as claimed in claim 1, wherein said method comprises application of at least two components of a).

6. The method as claimed in claim 1, wherein said herbicide is selected from the group consisting EPSP synthase inhibitors, acetyl CoA carboxylase inhibitors, glutamine synthetases, synthetic auxins, ALS inhibitors, and combinations thereof.

7. The method as claimed in claim 1, wherein said insecticide is selected from the group consisting of ache inhibitors, nicotinic acetylscholine receptors, inhibitors of chitin biosynthesis, GABA-gated chloride channel allosteric modulators, sodium channel modulators, juvenile harmone mimics, and combinations thereof.

8. The method as claimed in claim 1, wherein said fungicide is selected from the group consisting of demethylation inhibitors, quinone outside inhibitors, quinone inside inhibitors, amines, anilinopyrimidines, benzimidazoles, succinate dehydrogenase inhibitor, guanidines, and combinations thereof.

9. The method as claimed in claim 1, wherein said biostimulant is selected from the group consisting of seaweed extracts, folcysteine-based biostimulants, compositions of fulvic acid, amino acids, Inositol, laminarin, ascophylum nodusum extracts, superabsorbent polymers, hexadecenal, ortho silicic acid, plant growth regulators, fertilizers, and combinations thereof.

10. The method as claimed in claim 1, wherein applying increases the growth of a plant and a 15-20% increase of crop yield when applied in the field.

11. The method as claimed in claim 1, wherein a) and b) are applied as a tank-mix, a premix or a readymix formulation.

12. A kit of parts comprising
a) at least one biostimulant, and
b) at least one pesticide compound selected from groups i) to iii) and combinations thereof:
i) a herbicide
ii) an insecticide
iii) a fungicide.

13. The kit as claimed in claim 12, wherein said kit comprises ready formulations of the at least one biostimulant and the at least one pesticide selected from the groups i) to iii) and a user manual for a user to apply the products on a crop.

14. A method of stimulating or increasing plant growth comprising
applying a pesticide and a biostimulant as claimed in claim 1 to a plant or a part of a plant or locus thereof in an effective amount to enhance the growth and yield of the plant or plant (s) grown from the plant part.

15. The method of claim 14, wherein said pesticide is applied at a rate ranging from about 0.1 g/ha to about 5 kg/ha.

16. The method as claimed in claimed in claim 14, wherein said plant is selected from the group consisting of food crops, monocots, dicots, corn, rice, wheat, barley, rye, oat, sorghum, cotton, soybean, peanut, almond, buckwheat, beet, rapeseed, sunflower, sugar cane, tobacco, eggplant, tomato, pimento, pepper, potato, cucumber, pumpkin, zucchini, water melon, melon, squash, radish, white turnip, horseradish, kohlrabi, Chinese cabbage, cabbage, leaf mustard, broccoli, cauliflower, burdock, crown daisy, artichoke, lettuce, green onion, onion, garlic, asparagus, carrot, parsley, celery, parsnip, spinach, Swiss chard, Perilla frutescens, mint, basil, strawberry, sweet potato, Dioscorea japonica, colocasia, flowers, foliage plants, turf grasses, fruits: pome fruits such apple, pear, quince, peach, plum, nectarine, Prunus mume, cherry fruit, apricot, prune, orange, lemon, rime, grapefruit, chestnuts, walnuts, hazelnuts, almond, pistachio, cashew nuts, macadamia nuts, blueberry, cranberry, blackberry, raspberry, vines, kaki fruit, olive, plum, banana, oil palm, coffee, date palm, coconuts, trees other than fruit trees; tea, mulberry, flowering plants, ash, birch, dogwood, Eucalyptus, Ginkgo biloba, lilac, maple, quercus, poplar, judas tree, liquidambar formosana, plane tree, zelkova, Japanese arborvitae, fir wood, hemlock, juniper, Pinus, Picea, and Taxus cuspidate.

17. The method as claimed in claim 16, wherein said formulation is a tank-mix or premix or ready to use formulation.
